(19) United States
(12) Patent Application Publication
(10) Pub. No.: US 2018/0148246 A1
(43) Pub. Date: May 31, 2018

(54) INSULATED LAMINATES AND METHODS FOR MAKING SAME

(71) Applicant: LBP Manufacturing LLC, Cicero, IL (US)

(72) Inventors: Thomas Z. Fu, Naperville, IL (US); Pazam Subramanian, Chicago, IL (US); Irshad Kahn, Lake Villa, IL (US)

(21) Appl. No.: 15/827,876

(22) Filed: Nov. 30, 2017

Related U.S. Application Data
(60) Provisional application No. 62/428,093, filed on Nov. 30, 2016.

(51) Int. Cl. B65D 81/38; B65D 30/08

(52) U.S. Cl. CPC B65D 81/3897; B32B 5/18; B65D 31/04

(57) ABSTRACT

A flexible, insulating laminate comprising a first ply formed of paper, a second ply formed of paper, and an expandable insulating material comprising thermally activated expandable microspheres between the first ply and the second ply. An adhesive may be applied to provide a barrier between the insulating material and an outer edge of the laminate. The flexible laminate may be formed into a variety of end products such as bags, sheets, pillows, pads, and the like.

### CROSS-REFERENCE TO RELATED APPLICATION

This application claims the benefit of U.S. Provisional Patent Application 62/428,093, filed Nov. 30, 2016, which is hereby incorporated by reference in its entirety.

### TECHNICAL FIELD

This invention relates generally to insulated laminates, and more specifically relates to insulated laminate products and methods for making a multilayer laminate that may be formed into containers or other products, such as double layer bags and multi-layer pads having insulating material disposed between the layers.

### BACKGROUND

Paper bags are frequently used to carry cold groceries because they have better insulating properties than the thin, plastic bags used most commonly in retail sales. Some stores use double ply paper bags for bagging frozen foods to further increase the amount of insulation. Multi-wall paper bags for holding bulk products such as pet food, fertilizer, or charcoal are also known. In some double ply bags, an adhesive is used between the paper layers to bond the layers together to give the bag additional strength and resistance against tearing. In these bags, the adhesive is flooded onto the paper substrates so they are fully covered with adhesive. Insulated plastic bags are also sometimes used to transport cold or frozen foods. Typically, insulated plastic bags are relatively expensive and are not biodegradable or readily recyclable, which makes them less suited for single use applications.

As grocery delivery is growing more popular, problems are being found with existing packaging used for transporting groceries, and particularly cold items. Insulated boxes are bulky and expensive. They take up a relatively large amount of space to ship and store before being used to hold/deliver groceries, and they take up a large amount of space in the garbage or recycling of the end recipient. Existing paper bags do not provide sufficient insulation to keep frozen or cold groceries at or below threshold temperatures for the extended length of deliveries or when the groceries are left at the door of a recipient for extended periods of time.

Containers made with paperboard having thermally activated expandable insulating material disposed between the layers of paperboard are known, such as disclosed in U.S. Pat. No. 9,056,712, which is incorporated by reference in its entirety herein. However, these prior containers are rigid containers, such as cups or clamshells.

### SUMMARY

In one embodiment according to the present invention, a flexible insulated laminate includes first and second flexible ply portions each having inner facing surfaces that are bonded together with an adhesive along at least one edge of the first and second ply portions. An expanded insulating material including expanded microspheres is disposed on at least one of the inner facing surfaces of the first and second ply portions to space the ply portions apart and form at least one air void between the ply portions. The expanded insulating material is spaced inwardly from the at least one edge of the bonded first and second ply portions and the adhesive extends about the insulating material to keep the expanded insulating material from passing beyond the at least one edge of the bonded first and second ply portions. In some forms the adhesive forms a continuous perimeter around the expanded insulating material to seal the expanded insulating material within the at least one edge of the bonded first and second ply portions.

In some forms, the ply portions are two separate plies of material. In alternative forms, the ply portions are of a single ply of material folded over upon itself with the ply portions extending from a common fold line.

In some embodiments, the ply portions are of a paper material. An outer surface of one of the first and second ply portions may be coated with a water-resistant coating. For example, the ply portion may have an outer surface with the water-resistant coating having a Cobb value of less than 25 g/m̂2.

The flexible laminate can be formed into a variety of products. In one embodiment, the bonded first and second ply portions with the expanded insulating material and adhesive therebetween are formed into a collapsible bag with a base and opposing side and end walls extending from the base. The opposing side and end walls form a bag opening at uppermost edges of each of the side and end walls opposite from the base. An exterior surface of the bag is formed by one of the first and second ply portions, and interior surface of the bag is formed by the other of the first and second ply portions. In some forms of the bag, the opposing side and end walls are separated by preformed fold lines that extend from the base.

The opposing side and end walls each have a length measured from the base to the uppermost edge thereof. In some forms, each of the opposing side and end walls include an upper portion extending from the uppermost edge toward the bag base free from expanded insulating material. The length of the upper portion free from expanded insulating material can be preferably at least one eighth of the length of the respective opposing side or end wall.

In some forms of the bag, the adhesive extends between the first and second ply portions along the uppermost edges of each of the side and end walls in a non-continuous manner. Alternatively, the adhesive forms a continuous perimeter around the expanded insulating material to seal the expanded insulating material within the at least one edge of the bonded first and second ply portions.

The insulating material is applied so as to be spaced from each of the fold lines introduced to the flexible laminate such that the insulating material is not crushed or otherwise inhibited from expanding when the insulating material is heated during manufacture of the laminate.

In some embodiments, the flexible laminate has expanded insulating material configured to provide the flexible laminate with an R-value between 0.05 m̂2 K/W to 0.5 m̂2 K/W.

In some forms, the first and second ply portions with the expanded insulating material and adhesive therebetween are formed into an envelope.

In various embodiments, the expanded insulating material is arranged in a pattern of individual spaced apart portions that are aligned in a plurality of columns. In some forms, the expanded insulating material has a thickness between 0.1 and 0.5 inches.

Exemplary methods of making a flexible, insulating laminate are also described herein. A method of making a flexible insulating laminate includes applying an insulating material in an unexpanded form in a pattern to a first side of a first substrate portion, applying an adhesive material different from the unexpanded insulating material to the first side of the first substrate portion so that the adhesive material surrounds and is spaced from the unexpanded insulating material, and bonding a second substrate portion to the first side of the first substrate portion via the adhesive material to form an unexpanded laminate having the unexpanded insulating material disposed between the first and second substrate portions with the adhesive material surrounding and spaced from the unexpanded insulating material, and heating the unexpanded laminate to cause the unexpanded insulating material to expand to provide at least one air void between the bonded first and second substrates to form the flexible insulating laminate.

Some methods further include forming the unexpanded laminate into a collapsible bag. In some methods, the step of heating the unexpanded laminate occurs after forming the unexpanded laminate into a collapsible bag. In some forms, forming the unexpanded laminate into a collapsible bag includes forming fold lines in the unexpanded laminate for collapsing and expanding the bag in locations that are spaced from the unexpanded insulating material.

In some forms, the unexpanded laminate is heated using an industrial microwave. In some examples, the unexpanded insulating material is heated to a temperature of between 200 and 250 degrees Fahrenheit to cause expansion of the insulating material.

In some methods, the unexpanded insulating material includes unexpanded microspheres prior to heating of the insulating material, and after heating of the insulating material within a predetermined activation temperature range, the expanded insulating material comprises unruptured expanded microspheres.

In some forms, the unexpanded insulating material has a viscosity of between 3,000 and 4,500 centipoise at 72 degrees Fahrenheit. Alternatively or additionally, the unexpanded insulating material has a thickness ranging between 2 and 30 mil prior to being expanded by heating.

The insulating material is applied to the first substrate while the first substrate is advancing at a predetermined speed. In some forms, the unexpanded insulating material is applied to the first substrate while the first substrate is advanced at a speed greater than 100 ft/min. Some methods further include measuring the speed at which the first substrate is advanced, and applying the unexpanded insulating material in the pattern repeatedly at predetermined spaced apart locations on the first substrate based on the measured speed of the first substrate.

Some methods further include heating the unexpanded laminate to remove moisture from the unexpanded insulating material and allowing the dried insulating material to cool prior to heating the unexpanded laminate to cause the unexpanded insulating material to expand.

In some forms, the adhesive material is applied to form a continuous perimeter about the unexpanded insulating material to seal the unexpanded insulating material between the bonded first and second substrate portions.

Some methods further include forming fold lines in the bonded first and second substrate portions at predetermined locations spaced from the insulating material.

Systems used for making the flexible insulated laminates are also described herein. An inline system for making a flexible insulated laminate includes a roll for feeding a web of a first substrate to be processed, a roll for feeding a web of a second substrate to be processed, an insulating material applicator to apply a heat expandable insulating material to the first substrate web at predetermined insulating material locations on the first substrate web while the first substrate web is advanced in a machine direction, an adhesive applicator to apply an adhesive material to the first substrate web at predetermined adhesive locations on the first substrate web spaced from the applied expandable insulating material while the first substrate web is advanced in the machine direction, a pair of nip rolls to bond the second substrate web to the first substrate web at the predetermined adhesive locations while the substrate webs are advanced in the machine direction, a bag converter to convert the bonded first and second substrates into a collapsible bag while the bonded substrates are advanced in the machine direction, and a heater to heat the expandable insulating material disposed between the first and second substrates to cause the insulating material to expand while the bonded substrates are advanced in the machine direction.

In some systems, the insulating material applicator is a nozzle applicator having a plurality of nozzles for applying heat expandable insulating material arranged in a plurality of columns to the first substrate web. Some systems further include a flowmeter for measuring the amount of heat expandable insulating material applied to first substrate by the nozzle applicator.

Some systems further include a vision system having an optical detector for confirming the applied heat expandable insulating material is located at the predetermined insulating material locations on the first substrate.

Other features and advantages will be apparent from the following description of various embodiments, which illustrate, by way of example, the principles of the disclosed insulated laminates and systems and methods for making the same.

### BRIEF DESCRIPTION OF THE DRAWINGS

FIG. 1A is a view of an exemplary machine system schematic for making an insulated substrate for forming an insulated laminate.

FIG. 1B illustrates an alternate exemplary machine system schematic for making an insulated laminate.

FIG. 1C illustrates an alternate exemplary machine system schematic for making an insulated laminate.

FIG. 2 is a view of an exemplary machine system schematic for forming the insulated substrate of FIG. 1A into an insulated laminate.

FIG. 3A is a view of an exemplary machine system schematic for forming the insulated laminate of FIG. 2 into an insulated bag.

FIG. 3B is a view of an exemplary machine system schematic for forming the insulated laminate of FIG. 2 into an insulated pad.

FIG. 4A is a view of an exemplary machine system schematic for activating the insulating material in the insulated bags of FIG. 3A.

FIG. 4B is a plan view showing the process of collapsing an expanded bag.

FIG. 4C is a side view of the bag collapsing process shown in FIG. 4B.

FIG. 5A illustrates a first substrate of a bag blank illustrating a pattern of insulating material and a peripheral application of laminating adhesive surrounding the insulating material.

FIG. 5B illustrates a fully laminated bag blank prior to being assembled into a completed bag, illustrating the location of the seam and bag-bottom adhesive.

FIG. 6 is a perspective view of an exemplary insulated bag formed in FIG. 3A.

FIG. 7 is a plan view of an exemplary insulated pad formed in FIG. 3B.

FIGS. 8A-8C are cutaway views of the insulated pad of FIG. 7 with the second substrate removed illustrating three exemplary patterns of insulating material.

FIG. 9 is a partial enlarged, longitudinal cross-sectional view of a portion of a representation of an insulated bag illustrating the air gap between the laminated substrates and the expanded insulating material maintaining the air gap.

FIG. 10 illustrates an exemplary microsphere in an unexpanded and an expanded state.

FIG. 11 illustrates the bottom of a finished insulated bag formed from the blank of FIG. 5B.

FIG. 12 is an enlarged representation of expanded, non-ruptured microspheres disposed in the expanded insulating material.

FIG. 13 an alternate exemplary machine system schematic for making a collapsible bag formed from a flexible insulated laminate.

FIG. 14A is a perspective view of a simplified representation of a system for making laminated insulated inserts out of two flexible substrates and an expandable insulating material.

FIG. 14B is a top plan view of an insulated blank formed in the system of FIG. 14A. One ply of the insert is not shown so that the insulating material is visible.

FIG. 15 is a perspective view of a simplified representation of an alternate system for making the laminated insulated inserts.

FIG. 16A is a perspective view of a simplified representation of a system for making insulated laminate inserts out of a single sheet of substrate material.

FIG. 16B is a perspective view of an insulated blank formed in the system of FIG. 16A.

FIG. 17A is a perspective view of a simplified representation of an alternative system for making insulated laminate inserts.

FIG. 17B is a perspective view of an insulated blank formed in the system of FIG. 17A.

FIG. 18 is a perspective view of a simplified representation of an alternative system for making a roll of an insulated laminate perforated for separation into separate inserts.

Elements in the figures are illustrated for simplicity and clarity and have not necessarily been drawn to scale or to include all features, options or attachments. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

A flexible, insulated laminate includes one or more flexible substrates of various materials, such as but not limited to kraft paper, plastic, metallized paper, metallized plastic films, upon which an expandable insulating material is disposed. In some forms, the expandable insulating material is applied to a first flexible substrate. Depending upon the composition of the expandable material, it is either dried for later expansion (activation), is partially expanded, or is fully expanded before further processing of the laminate into a final product. In some forms, the expandable insulating material is applied in a predetermined pattern, such as in an array of spaced-apart areas of insulating material or in other forms, it may be applied in a random and arbitrary pattern. A laminating adhesive may be applied in a manner to surround the expandable insulating material for bonding a second flexible substrate to the first flexible substrate. The laminating adhesive is of a different material composition from that of the expandable insulating material and performs the function of bonding the substrates together securely. In an industrial process for making the laminate, a web of one of the substrates is conveyed in a longitudinal machine direction and the laminating adhesive is applied along both of the lateral edges of the substrate that extend in the longitudinal machine direction. Laminating adhesive is also applied to the substrate at predetermined and successively longitudinally-spaced locations so that the applied adhesive extends transversely to the machine direction. Accordingly, the laminating adhesive effectively extends around the entire perimeter of the applied insulating material in order to completely seal in the insulating material once a second flexible substrate is bonded to the first substrate. When the substrates are bonded to each other at the respective lateral edges and at the predetermined transverse locations between the lateral edges, the first and second substrates will be in registration, i.e., with the lateral edges of one substrate aligned with the corresponding lateral edges of the other substrate such that there are no offset portions of one substrate from the other substrate adhered thereto. Alternatively, the lateral edges of the substrates may be offset from one another assuming the insulating material and the laminating adhesive are in registration with one another. After bonding of the substrates, the expandable insulating material is disposed and sealed therebetween, thereby forming a sealed, flexible and insulated laminate. Completely sealing in the insulating material is preferred to reduce the likelihood of the expanded insulating material from escaping from the formed laminate.

In some forms, the expandable insulating material may be dried, such as by application of heat, prior to being expanded. For example, the dried but not expanded thermally expandable insulating material can be further heated and hence activated or expanded just after the sealed laminate is formed. Alternatively, the expandable insulating material can be further heated and activated or expanded after the laminate is later formed into a partially finished or completely finished product. When the expandable insulating material is applied in non-continuous layer, such as a pattern or array of spaced areas that each have a predetermined shape, the insulating material, when expanded, acts as an array of spacers that create spaces between the first and second substrates. Air gaps are formed in the space between the spaced apart first and second substrates where the substrates are not adhered to each other and where the insulating material is not present. The composition of the insulating material, when fully activated or expanded, creates relatively large air gaps which provide significant insulating qualities to the laminate and further contributes to the flexibility thereof so as to provide a cushioned, flexible, laminated structure with a scalable thermal insulation level depending on the thickness of the expanded insulating material in the finished products. It was discovered that a relatively small amount of expandable insulating material could provide the laminate with good insulating qualities. When made with paper substrates, such a laminate is also environmentally friendly in that it is repulpable and recyclable.

The flexible, insulated laminate can be constructed into various forms including containers, such as grocery bags or insulating packaging, mailers, inserts, or pads. For example, an insulated pad formed from the insulated laminate could be used within a hot food container such as a pizza box. Products formed with the insulated laminate include one or more adhesive-sealed cushioned panels having expanded insulating material that form air gaps to provide additional insulating properties. The sealed panels are particularly suited for use with food products, as the insulating material is kept separate from and out of contact with the food products via the sealing provided by the laminating adhesive. Items made of a flexible, insulated laminate can be collapsed or flattened and compressed for shipping and storage, and can be bent, folded, and/or rolled in use without being damaged. When the insulated laminate is formed into flexible containers such as bags, the containers advantageously may be of variable size, for example by rolling up the top part of an open bag such that the interior volume of the bag closely matches the volume of the contents held within the bag, thereby increasing the insulative effectiveness of the bag. In this regard, the bag can be free of the insulating material at and near the top of the bag since this part of the bag is to be folded over.

In one form, an insulated bag is constructed of a flexible paper laminate containing an expandable insulating material between the paper layers. The insulating material is fixed to either the outer surface of the inner paper layer or the inside surface of the outer layer. In general, the insulating material is fixed to only one of the substrates, and the opposing substrate will only engage the insulating material and will not be fixed to it because the insulating material applied to one of the substrates is dried or expanded prior to bonding the opposing substrate to the one substrate. However, in an alternative form, the insulating material could be bonded to both substrates. A continuously formed laminate can be die-cut to form a bag blank that will be later processed within a bag making machine, or the lamination can be directly fed into the bag making machine. Alternatively, the lamination of the substrates can be accomplished by the bag machine itself. In each case, the bag making machine will fold and glue the laminate into the final shape of a bag. The insulated bag described herein has an open top and is made of a flexible material and includes a flexible insulating material so that the bag can be folded and used without damaging the insulating material layer.

In another form, a flexible insulating laminate can be die cut into an insulated pad that can be placed within a food container to provide improved heat retention of the food product by reducing the amount of heat being lost by the food product through the container walls. For example, the insulating laminate pad may be cut into a circle, square, or any other shape that roughly conforms to the size and shape of the interior of a container. In one application, the pad may be used in conjunction with a typical pizza box container. The pad would be placed inside the pizza box on the base thereof, and would support the underside of a pizza. In this application, the insulated pad was found to be very effective in slowing the rate at which the pizza cools by keeping heat emitted from the pizza from rapidly transferring to and out of the bottom wall of the box and to the exterior environment. If desired, another insulated pad can be attached to a top interior of the pizza box to further reduce heat losses through the top wall. The insulated pad may be formed with one or more substrates having non-flat surface features, such as embossed or fluted air flow channels, and may be particularly adapted to absorb steam or moisture.

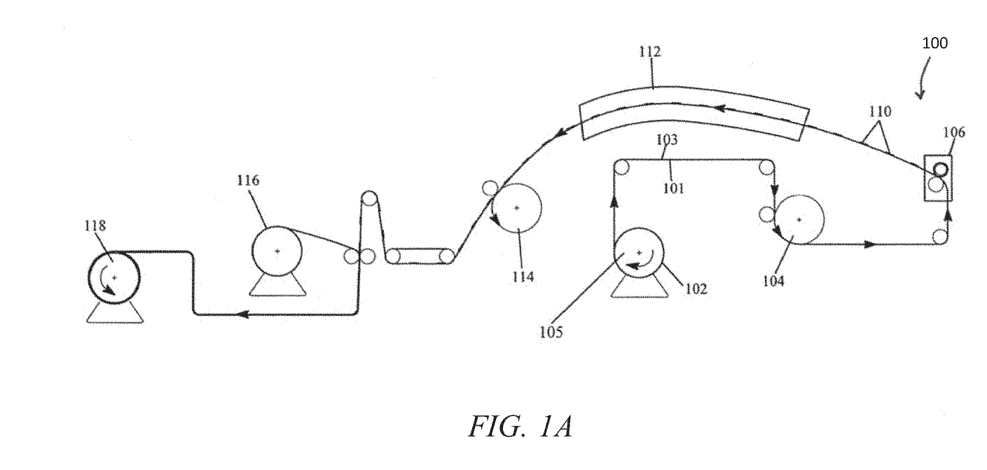

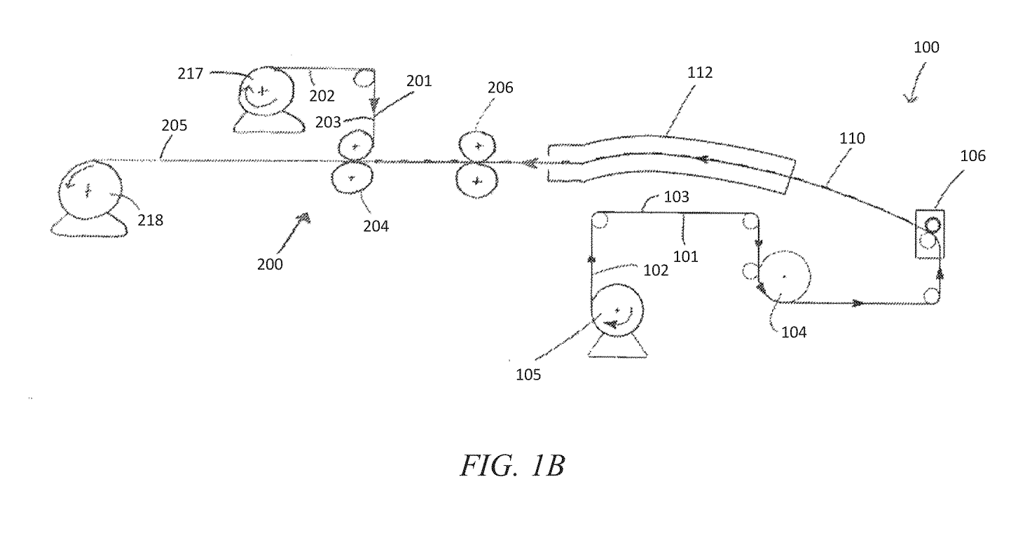

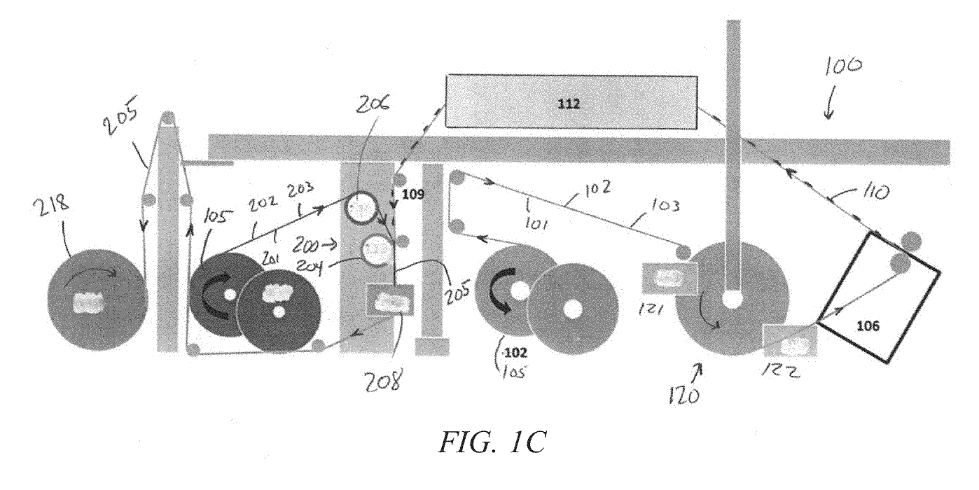

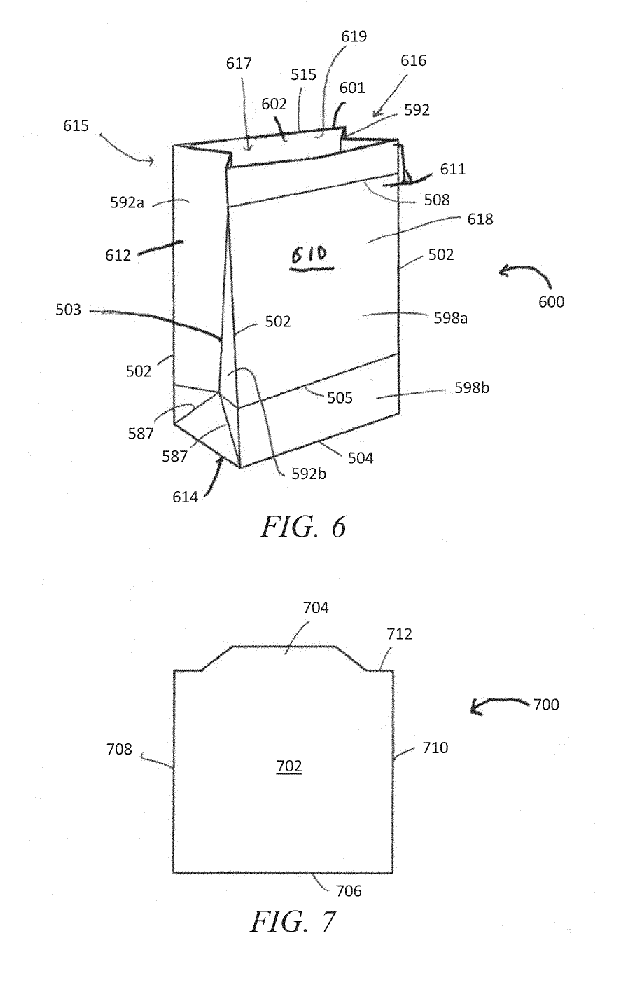

One method of manufacturing a flexible insulated laminate is now described. Other alternative methods will be described later. The first substrate 102 in web form is unwound from its roll 105 as shown in FIG. 1A. When made into a finished bag 600 (see FIG. 6), the first substrate 102 can form either the inside layer material or the outside layer material of the bag 600. In the embodiment shown, the first substrate 102 becomes the inside layer of the bag 600. The substrate 102 can be made of a wide variety of materials, preferably paper, although other materials could be used. Some of the materials include, but are not limited to, synthetic paper, plastic, non-woven materials, metal films, and coated papers. Examples of paper substrates include fluted papers, single face or double face corrugated paper, paperboard, folding carton board, bleached or unbleached paper, metalized paper, and kraft paper. Examples of plastic substrates include polyolefin films, nylon films, PET, cavitated films, foamed films, and anti-static films. Examples of non-woven materials include air laid paper, synthetic non-woven or multilayered non-woven fabrics. In a preferred embodiment, the substrate 102 is kraft paper with a water impermeable or resistant barrier coating on one surface. In particular, the first substrate 102 is made of 53# kraft paper and the water-resistant barrier coating is preferably formed of a recyclable material such as an aqueous acrylic-based coating or aqueous polyester copolymer coating made from reclaimed PET plastics. A coating that is compostable may be used too. In this particular application, the barrier coating is only applied to the second side or surface 103 of the first substrate 102 which will form the inner surface of the bag 600, which will eventually become the food contacting surface of the bag. When the laminate is to be formed into a pad or insert 700, the coated second side 103 will be the surface which contacts the food.

As shown in FIGS. 1A & 1B, the first substrate 102 is fed by a series of rollers 104 to an applicator 106. In a preferred embodiment, the applicator 106 is a screen printer or liquid extrusion applicator, e.g. a slotted die or a nozzle applicator. Compared with other printing methods, screen printing and liquid extrusion application processes allow for depositing a relatively thicker layer of material on a substrate, and therefore are particularly conducive to printing the desired thickness of wet insulating material, such as between 3 and 10 mil, at a single printing station. If a screen printer is used, the mesh size of the screen should be selected to allow the insulating material 110, including any solid components therein, such as microspheres having a diameter of between 4 to 50 microns, and more particularly an average diameter of 10 to 15 microns, to pass through. The screen mesh may range between 30 to 200 lines per inch, and more preferably 40 to 100 lines per inch. Other printing or coating application methods can be used to apply the insulating material to the substrate. The applicator 106 applies an insulating material 110 to a first side or surface 101 of the first substrate 102. The second side or surface 103 of first substrate 102 has already been pre-treated with a water barrier coating. In one form, the insulating material 110 is an expandable insulating material. In one preferred form, the insulating material is activated by heating. The insulating material 110 may be expandable when wet or dry, depending upon the method of heating used.

The expandable insulating material 110 contains a binder agent, heat expandable microspheres, and other common additives used in formulating an aqueous coating, such as rheological modifiers, defoamers, and so on. FIG. 10 illustrates a microsphere 1000 in an unexpanded state 1002 and an expanded, non-ruptured state 1004. A liquid hydrocarbon 1006, such as isobutene, is encapsulated within the microsphere shell 1008. Heating the insulating material 110 causes the liquid hydrocarbon to turn into a gas, and the vapor pressure of the expanding gas increases the internal pressure against the shell 1008 of the microspheres, which are likewise being heated and softened by the heating. As the insulating material is increasingly heated to its full activation temperature, the gas vapor pressure continues to increase such that the increased pressure forces the shell 108 of the microspheres to likewise expand. As seen, the shell 1008 is substantially thinner when the microsphere 1000 is in a fully expanded state 1004 compared to an unexpanded state 1002. In some forms, the microspheres are formed of a polyacrylonitrile polymer. In a preferred form, the insulating material 110 is heated within an oven that is heated to a temperature between 330 degrees Fahrenheit and 450 degrees Fahrenheit in order to activate the microspheres within the binder and to fully expand them to the state shown in FIG. 10. In a preferred form, the activation temperature of the microspheres is substantially higher than the drying temperature of the insulating material in order to eliminate and/or minimize the potential of significant pre-expansion of microspheres during a drying process. Overheating the insulating material beyond that maximum activation temperature will cause over expansion and rupturing of the shell of the microspheres 1008, causing them to collapse upon themselves and reducing the effectiveness of the insulating material to function as a spacer and insulator. Preferably, the insulating material, and hence the expandable microspheres therein, should be uniformly heated as much as possible so the microspheres are substantially expanded uniformly, such that the insulating material 110 maintains a generally uniform profile in all directions, not just in the direction of the thickness of the applied layer of insulating material. With the chosen composition of insulating material of the invention, the post-expansion thickness of the insulating material 110 may be 10-60 times thicker than the unexpanded thickness. In a preferred embodiment, the expanded thickness of the insulating material 110 is 20-40 times thicker than the unexpanded thickness.

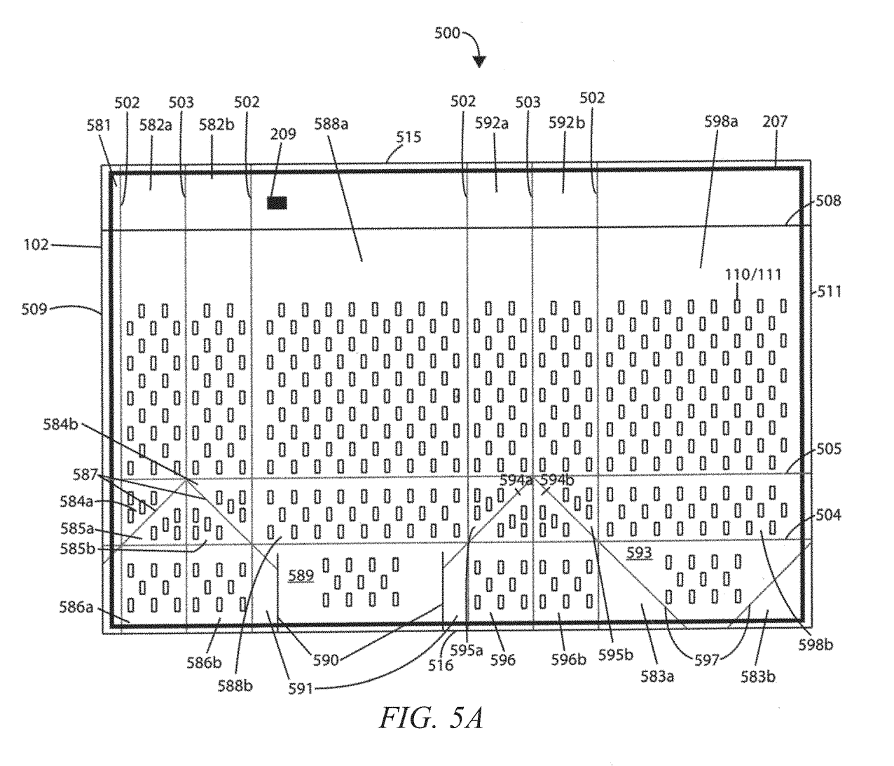

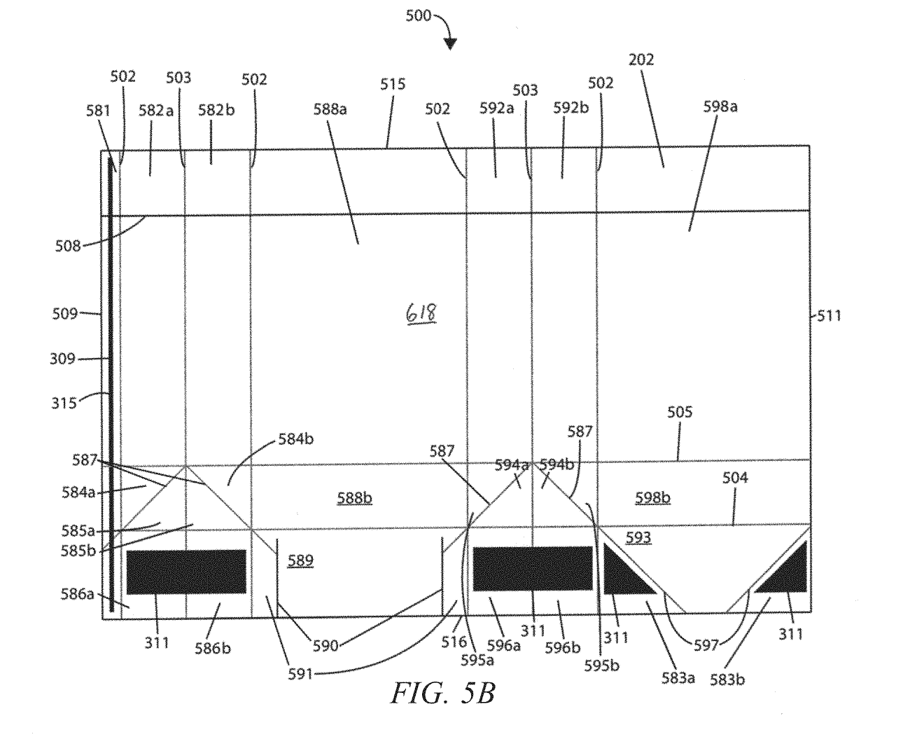

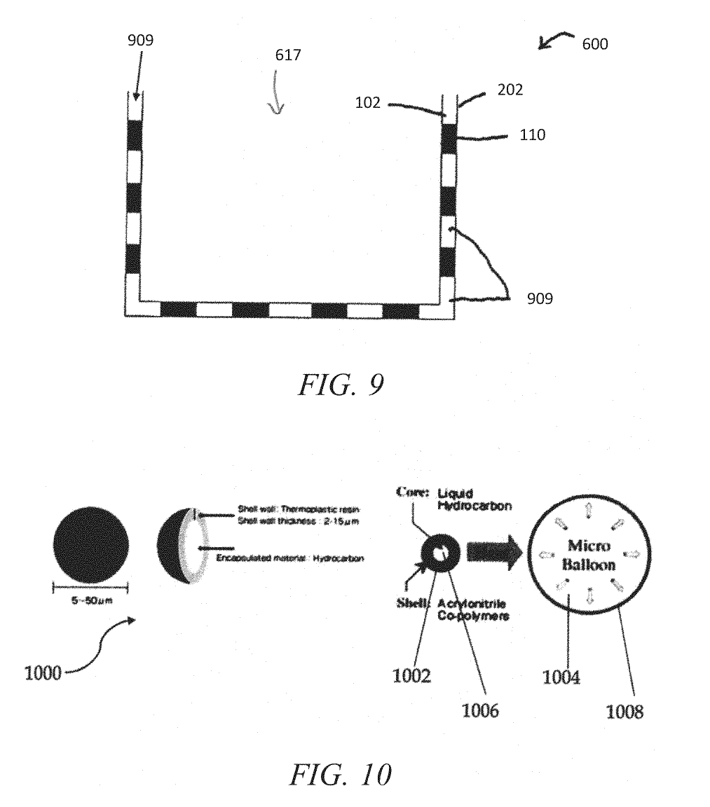

The binder solution in which the microspheres are embedded may include rheology modifiers, resins, plasticizers, thickeners, surfactants, and solvents. The applicator can apply the insulating material 110 at varying wet thicknesses depending on the desired insulative properties (i.e. R-value) of the insulated laminate. The insulating material 110 should be fluid enough to be applied by the applicator 106 but viscous enough to maintain the insulating material in the areas of the pattern in which it is applied so it does not flow out of these areas after application of the insulating material. In one form, the wet insulating material 110 is applied in a 2 mil-30 mil thick layer. In a more preferred form, the wet insulating material 110 is applied in a layer that is between 3 mil-10 mil thick. After full expansion of the microspheres, the insulating material 110 will be between 0.1 inches to 0.5 inches thick. In a preferred embodiment, the insulating material 110 is 0.15 inches to 0.3 inches thick after expansion. As mentioned earlier, the insulating material may be used primarily as a spacer to keep the substrates apart such that one or more insulative spaces or air gaps 909, is formed and maintained between the substrates (see FIG. 9). Depending on the arrangement of the insulating material 110, there may be one continuous air gap, or a plurality of separate air gaps isolated from one another between the substrates and open spaces between the insulating material. The air within the air gap space 909 serves as the primary insulator between the substrates. FIG. 9 represents a portion of a cross section of a finished bag 600 that has a particular insulating material application pattern and is provided to illustrate that the insulating material acts as a spacer to create and maintain an air gap between the substrates that form the bag. However, it should be understood that FIG. 9 is not drawn to scale and therefore is not representative of the cross section of a bag formed with the pattern identified in FIG. 5A. As can be seen, the insulating material 110 only fills a small portion of the space 909. In a currently preferred form, the insulating material is Aquence® ENV 42000 MFA available through Henkel Corporation. However, other insulating materials could be used.

The insulating material 110 can be applied in a variety of patterns to one of the substrates. Preferably, the insulating material 110 is applied so it is spaced from all locations where the substrate laminating adhesive will be applied and from locations where fold lines will be located. For example, FIG. 5A shows the first substrate 102 of the bag blank laminate 500 with the second substrate 202 removed to illustrate this point. As shown and described herein, the blank 500 is a portion of the laminate 205 sized and configured to be folded to form a bag 600. The blank 500 comprises the first substrate 102 and the second substrate 202 separated by the insulating material 110. When the insulating material 110 is expanded, the insulating material 110 acts as a spacer between the substrates 102, 202, thereby forming an air gap 909 between the substrates 102, 202 (see FIG. 9).

In FIG. 5A, one possible pattern of the insulating material 110 is arranged so as to be spaced from each fold line and each edge of the bag. This is done for several reasons. First, spacing the insulating material 110 from the areas to be folded promotes easier folding of the bag blank 500 into a bag 600 and allows the insulating material to expand without restriction by a laminating or seam adhesive, or by a fold line in the case where the insulating material is expanded after folding of the laminate into a bag 600 or other product. By spacing the insulating material 110 from fold lines and areas where the substrates are bonded together, the insulating material is located only in areas where the substrates are allowed to move apart from one another such that the substrates will not inhibit expansion of the insulating material. It also keeps the fully expanded insulating material 110 from being damaged during the bag folding process. FIG. 5B shows the side of the bag blank laminate 500 that will become the outer surface of the bag 618. The inner surface 201 (not shown) of the second substrate 202 is bonded to the first side 101 of the first substrate 102. The outside surface 203 of the second substrate will have adhesive applied thereto in specific locations for forming the bag. As illustrated, a seam adhesive 309 is applied to form a longitudinally extending glue seam 315 on the outer surface 618 of the blank at a glue flap or overlap portion 581 of the blank 500 for bonding the outer surface 618 of the blank to the inner surface 619 of the blank, i.e., the side of the blank that forms the inside of the bag 600. The glue seam 315 is located away from areas containing the insulating material 110.

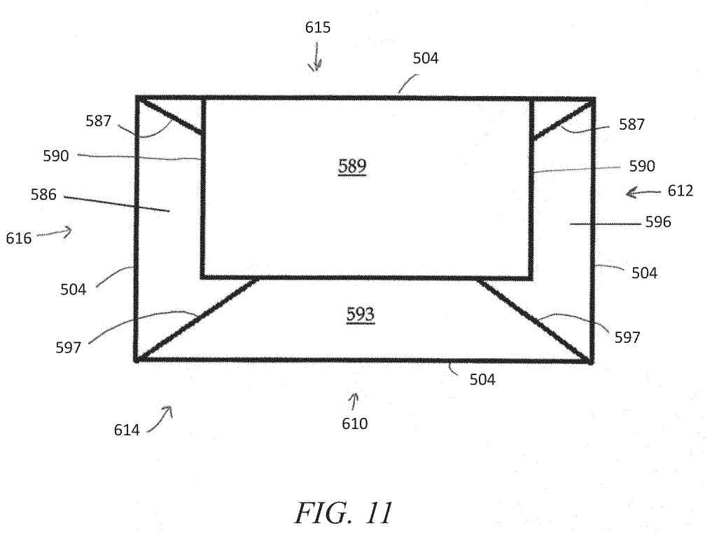

As shown in FIG. 5A, the insulating material 110 is applied in small rectangular areas 111 that are spaced from each other so that there is a predetermined pattern of insulating material containing rectangular areas applied to the substrate. The predetermined pattern of insulating material is applied to the first substrate 102 at locations on the first substrate that, when bonded with the second substrate 202, form insulated panels of the finished bag 600, seen in FIG. 6. The panels are delineated by fold lines and the edges of the blank 500 and the pattern of insulating material is applied so as to be spaced from each edge and fold line. In particular, the insulating material 110 is applied to the locations on the first substrate 102 that form upper and lower rear panels 588a and 588b of the laminated blank 500, which when assembled form rear side wall 615 of the bag 600 (See FIG. 6). Similarly, the insulating material 110 is applied to the substrate 102 at locations that form upper and lower front panels 598a and 598b, which when assembled form front side wall 610. In like manner, the insulating material 110 is located on the end wall panels including adjacent rectangular upper end panels 582a and 582b, and triangular lower end panels 584a, 585a, 584b, and 585b that together form end wall 616 of bag 600, and opposite end wall panels including adjacent rectangular upper end panels 592a, 592b, and triangular lower end panels 595a, 594a, 594b, and 595b that form opposite end wall 612 of the bag 600 shown in FIG. 6. In addition, insulating material 110 is disposed on six of the bottom panels 586a, 586b, 589, 596a, 596b, and 593 that cooperate to form the bottom 614 of the bag 600 (shown in FIGS. 6 and 11). Accordingly, the blank 500 is provided with 16 distinct areas of insulating material 110 corresponding to 16 distinct panels of the bag 600.

In one form, the insulating material 110 at its closest point, e.g., the edge of the closest rectangular area or areas of insulating material 111, is spaced apart from the fold lines 502, 503, 504, 505, 587, 597 by 0.5 inches-1 inch. In a preferred form, the insulating material 110 at its closest point is spaced apart from the fold lines by 11/16 of an inch. Additionally, the insulating material 110 may be spaced apart from the top of the blank 500. In use, the top portion 611 of the bag 600 shown in FIG. 6 may be folded or rolled down. The area that is rolled or folded can be left without insulating material 110. Preferably, at least the top one-eighth of the bag is free from insulating material. In one form, the top seven inches of the bag 600 contains no insulating material.

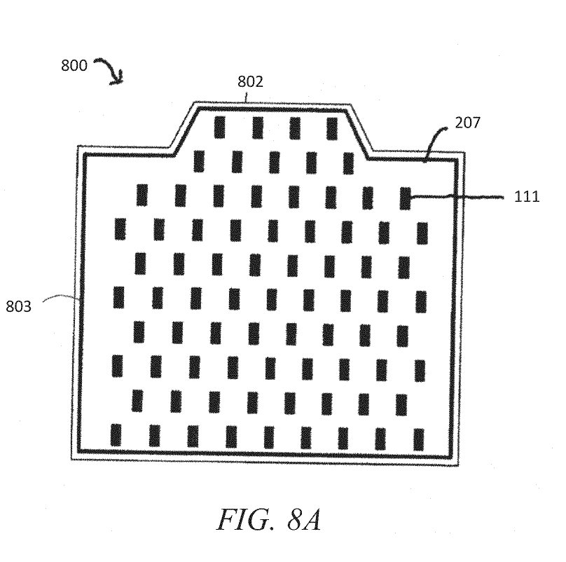

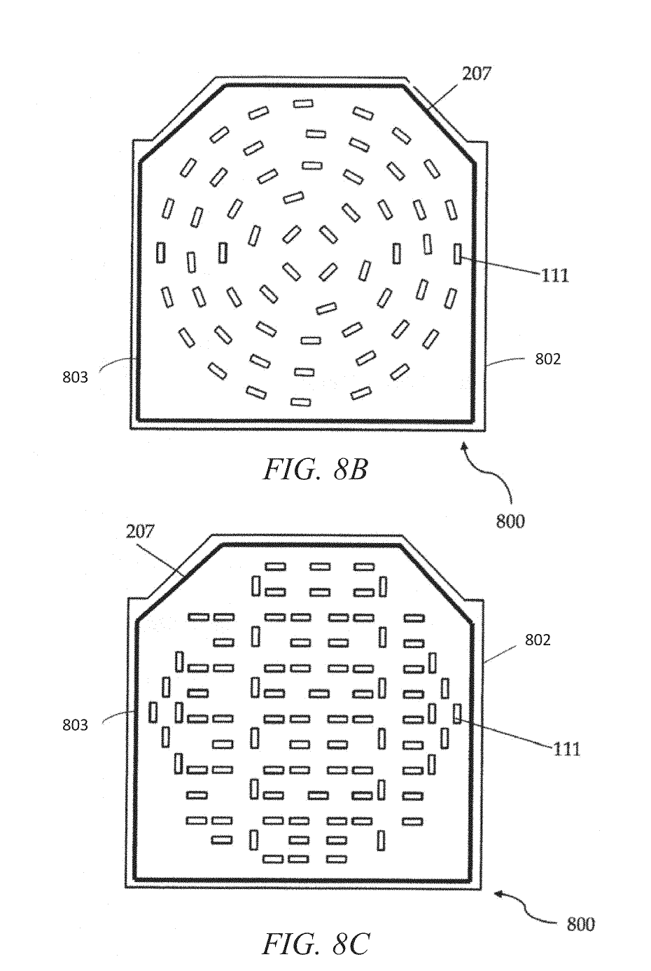

The insulating material 110 may be applied to the first substrate 102 in a variety of patterns. In one form, the insulating material 110 is applied in an array of rectangular areas 111 of substantially equal size as shown in FIGS. 5A and 8A-8C. The rectangles 111 can vary in orientation, with some being perpendicular to others. In one form shown in FIGS. 5A and 8A, the pattern comprises rectangular areas 111 arranged into a series of parallel rows. The rectangular areas 111 are all oriented in the same direction, meaning the long side of each of the rectangular areas 111 runs in the same direction. Adjacent rows or rectangular areas 111 are offset such that the rectangular areas 111 in a row are roughly centered on the center of the gaps between rectangular areas 111 in the adjacent rows. As shown in FIG. 5A, the rectangular areas 111 in each of the bottom panels 586a, 586b, 589, 596a, 596b, and 593 are spaced apart from the bottom edge 516 of the blank 500. This spacing provides room for the laminating adhesive 207 to be applied between the bottom edge 516 and the closest portion of the insulating material 110. The position of the applied pattern also keeps any portion of the finished bag from having two layers of insulation. When the blank 500 is folded to form the bag 600, the bottom portions 586a, 586b, 589, 596a, 596b, and 593 overlap each other (see FIG. 11) such that the uninsulated bottom portions will overlap and insulated portions will not overlap. Thus, the formed bottom 614 of the bag 600 will have a substantially uniform coverage of insulating material 110. In alternative forms, the bottom portions 586a, 586b, 589, 596a, 596b, and 593 may have an alternate configuration or the insulating material 110 may be applied to the bottom portions 586a, 586b, 589, 596a, 596b, and 593 in a manner such that when the bag 600 is formed, the bottom 614 has overlapping layers of insulating material 110, such that two layers of insulated laminate will be present in the overlapping locations with a first paper layer, a layer of insulating material, a second layer of paper, a third layer of paper, a second layer of insulating material, and a fourth layer of paper. This increases the insulating qualities of the bottom 614 of the bag which is in direct contact with the payload in normal use and which may be partially compressed by the weight of the payload.

The spacing between the rectangular areas 111 of insulating material 110 can vary as well such that they are either more tightly or loosely spaced from the spacing that is shown in the figures. FIG. 5A shows the rectangular areas 111 cover less than 50% of the first surface 101 of the first substrate 102. In still further forms, the rectangular areas are more loosely spaced, as shown in FIGS. 8A-8C, where it is seen they cover less than 25% of the first surface 101 of the first substrate 102. In alternative forms, the insulating material 110 can be applied in other shapes such as circles, arches, triangles, bands, and in other patterns, such as a completely random pattern.

Continuing with the description of the process shown in FIG. 1A, after the insulating material 110 is applied to the first substrate 102, the web that forms the first substrate 102 is pulled between nips formed by roller pairs and conveyed through a heater 112. The heater 112 is used to dry out the insulating material 110, which also keeps the first substrate 102 from wrinkling or cockling due to prolonged exposure to water in the insulating material 110. The drying out of the insulating material 110 also solidifies the solid contents of the insulating material 110 and keeps the insulating material 110 from being smeared during further processing. In one embodiment, the temperature of the insulating material 110 is kept below 212 degrees Fahrenheit when it passes through the oven in order to keep the microspheres from being activated, and also prevent the water contained in the insulating material from boiling, which can disrupt the applied pattern of the insulating material. In one embodiment, the heater 112 is a hot air heater or convection heater. In alternative embodiments, other types of heaters may be used such as radiation, infrared, or microwave heaters. In embodiments using an industrial microwave as the heating element, the insulating material 110 preferably contains a relatively sufficient water content for the insulating material to absorb the microwave energy, convert it to heat, and expand the material. For example, the insulating material may contain between 10% to 98% water by weight, and preferably between 30% to 80% water by weight for efficient heating and expanding the material. In a preferred embodiment, an insulating material 110 configured for drying via microwave heating comprises 1-18% microspheres by weight. When the insulating material 110 is configured to be dried via convection, radiation, or infrared heating, the insulating material will comprise 3-20% microspheres by weight, preferably 3-18% microspheres by weight, and the temperature of the heater 112 varies from 120 degrees Fahrenheit to 450 degrees Fahrenheit depending on the speed of the machine line 100. The faster the substrate 102 moves through the heater 112, the higher the temperature of the heater 112 must be in order to dry out the insulating material 110. In one embodiment, the substrate 102 is conveyed at between 100 ft/min and 1000 ft/min. In one form, the temperature of the heater 112 is between 135 degrees Fahrenheit and 225 degrees Fahrenheit. After drying, the insulating material 110 is solid to the touch, but still pliable. In other words, the insulating material 110 compresses when touched, but does not smear.

In a preferred form, the temperature of the heater 112 and speed of the conveyed substrate 102 is set so that the applied heat does not activate the microspheres 1000 in the insulating material 110, or at least does not fully activate the microspheres. Instead the drying creates a “dormant” insulating material 110 comprising unexpanded microspheres or partially expanded microspheres embedded in a dry binder. This dormant insulating material 110 can be fully activated at a later time in a “post-activation” process by applying additional heat after the insulated laminate 205 is formed. By pre-drying the insulating material 110, the first substrate 102 upon which the insulating material 110 is bonded may be easily and more compactly rolled up for later processing, and the second substrate 202 may be laminated to the first substrate 102, without disrupting the applied pattern of the still wet insulating material 110 on the first substrate 102. In a preferred embodiment, the insulating material 110 is dried out without activating any of the microspheres 1000. However, if higher temperatures are used in the heater 112 in order to reduce the amount of time required to dry out the insulating material 110, this higher temperature can cause some partial activation of the microspheres 1000. Full activation of the microspheres may be avoided by keeping the average temperature of the insulating material 110 under 225 degrees Fahrenheit. The activation temperature of the microspheres 1000 can be altered by changing the encapsulated liquid and or the wall thickness of the microspheres. In order to allow for later activation of the microspheres 1000, the insulating material 110 is preferably formulated to remain elastic once dried to allow the microspheres to expand. If the insulating material 110 is not sufficiently elastic when dried, the microspheres embedded in the insulating material 110 will not be able to overcome the rigidity of the surrounding solid components of the insulating material (such as the binder) and as a result the microspheres will not be allowed to expand.

After passing through the heater 112 shown in FIG. 1A, the first substrate 102 is advanced through additional rollers 114. The rollers 114 can optionally include chill rolls to rapidly reduce the temperature of the first substrate 102 and applied insulating material 110 after being heated.

After the initial heating process, the first substrate 102 may be rolled up, preferably with a protective layer for being stored and/or transported to another line for lamination of a second substrate and subsequent processing. Alternatively, this step could be skipped and the lamination of the second substrate 202 could be done immediately after the process of drying or activating the insulating material, such as shown in the alternative processes shown in FIGS. 1B and 1C. In addition, the second substrate 202 could be applied to the first substrate 102 prior to drying or activating the insulating material 110.

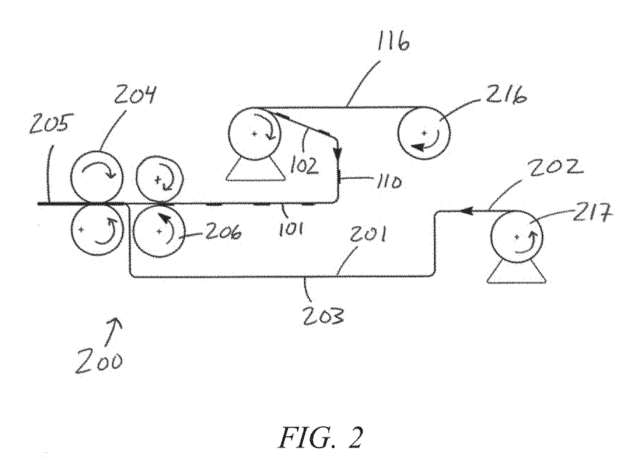

If the first substrate 102 is not being laminated to the second substrate immediately after the insulating material 110 is applied and dried or activated, a slip film 116 may be applied, but not bonded, to the first substrate 102 on the side 101 having the insulating material 110. The insulating material 110 is sandwiched between the first substrate 102 and the slip film 116. The slip film 116 serves to protect the insulating material 110 during rewinding of the first substrate 102 onto a roll 118 and keeps the insulating material 110 from sticking to the opposite surface 103 of the first substrate 102 as the first substrate 102 is rolled up. The slip film 116 is made of a material to which the insulating material 110 will not stick. In a preferred embodiment, the slip film 116 is a plastic film, such as a polyester film. The first substrate 102 and slip film 116 are rewound to form a roll 118. The dormant insulating material 110 is compressible and due to the elastic qualities of the dried binder will largely return to its original thickness, or nearly to its original thickness once the first substrate 102 is later unwound again for further processing. The thickness of the dormant insulating material 110 will be similar to, or slightly greater than the thickness of the applied insulating material before it is dried, depending on the degree of expansion of the insulating material during the drying process. The roll 118 of first substrate 102 with dormant expandable insulating material 110 can be stored for extended periods of time before being used to make finished products, such as insulated bags 600 or insulated inserts 700. When the first substrate 102 is used to make a bag 600 with a bag making machine line 300 or an insert 700 with an insert making machine line 350, it must first be formed into a laminate 205 with a laminate making machine line 200. The first substrate 102 is unwound and the slip film 116 is removed as shown in FIG. 2. The slip film 116 is recovered by a slip film pickup 216. The slip film pickup 216 is operable to pull the slip film 116 away from the first substrate 102 after the first substrate 102 is unwound. Because none of the insulating material 110 sticks to the slip film 116, the slip film 116 can be reused.

After passing through the heater 112 shown in FIG. 1A, the first substrate 102 is advanced through additional rollers 114. The rollers 114 can optionally include chill rolls to rapidly reduce the temperature of the first substrate 102 and applied insulating material 110 after being heated.

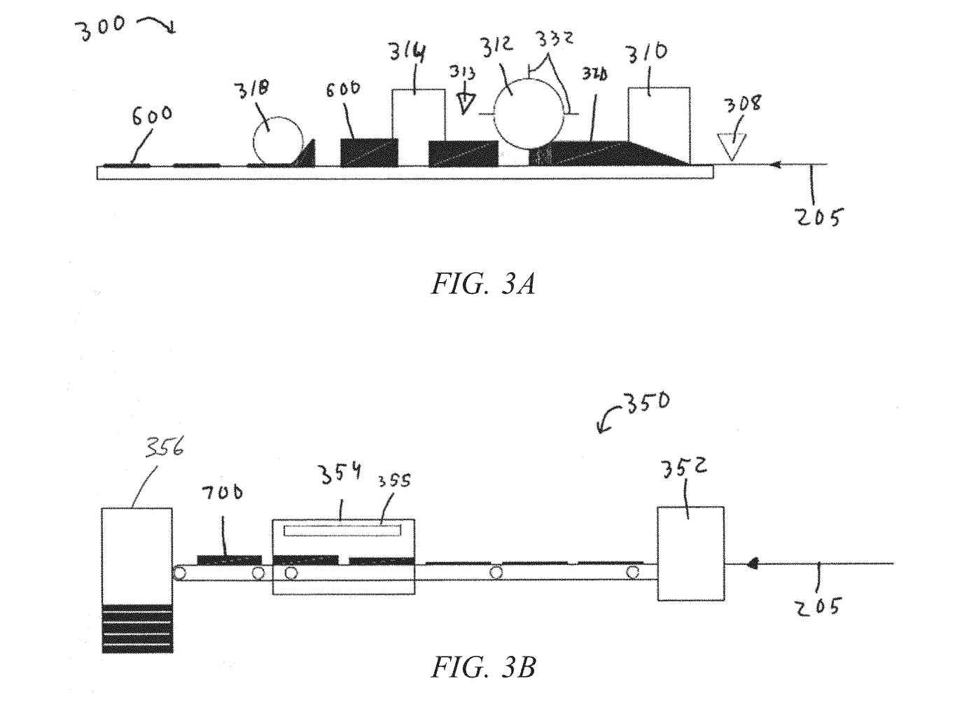

In the process for making a flexible insulated laminate 205 using the first substrate 102 having the insulating material 110 bonded to a first surface 101 thereof, a second substrate 202 in web form is unwound from roll 217 and fed into the laminate making machine 200, as shown in FIGS. 2 and 3A. As with the first substrate 102, the second substrate 202 can be formed of a variety of materials, preferably paper. Materials that could be used include kraft paper, coated paper, metallized paper, metal foil, corrugated paper, paperboard, corrugated paperboard, or plastic film or sheet. The corrugated materials can vary in type of corrugation, including E-flute. In one embodiment the second substrate 202 is formed of uncoated kraft paper. A laminating adhesive applicator 206 applies laminating adhesive 207 to at least one of the two substrates 102/202. The pattern of the laminating adhesive depends on the final product that will be formed from the laminate. A pattern of laminating adhesive 207 which can be used in the production of insulating bags 600 is shown in FIG. 6. A pattern of laminating adhesive 207 which can be used in the production of insulating inserts 700 is shown in FIGS. 8A-8C. The laminating adhesive applicator 206 can be any type of applicator, such as a flexographic applicator, a silk screen applicator, or a spray nozzle applicator. The laminating adhesive 207 can be a hot melt adhesive so that it sets quickly. In other forms, the laminating adhesive is an aqueous based PVA type of glue, an emulsion based glue, or a specialty hot melt glue that exhibits high heat resistant properties. In a currently preferred embodiment, the laminating adhesive 207 is Aquence® CORE 3160UV, CG9012 or BG 727A available through Henkel Corporation.

The laminating adhesive 207 may be applied within some of the regions not covered with insulating material 110, depending upon the end-use of the laminate 205. As shown in FIG. 2, the laminating adhesive applicator 206 applies adhesive 207 to the first surface 101 of the first substrate 102. The laminating adhesive applicator 206 or the controller of the laminating adhesive applicator 206 is in communication with a sensor configured to detect the location of the insulating material 110, such as by use of a registration mark 209 printed on the surface 101 of the first substrate 102 located ahead of the insulating material 110 as the first substrate 102 is conveyed through the laminate making machine 200. The sensor is a visual sensor that recognizes the presence of the registration mark 209 or alternatively the presence or absence of the insulating material 110 itself. The insulating material applicator 106 may be configured to print a registration mark 209 on the first substrate 102 at a predetermined point downstream of the insulating material 110 corresponding to each blank 500. Alternatively, a separate printer may be used to print the registration mark 209, such as a flexographic printer 120 as shown in FIG. 1C. The sensor of the laminating adhesive applicator 206 then senses the registration mark 209 for properly registering the application of adhesive 207 to the first substrate 102. For example, a control system uses information regarding the detected location of the registration mark 209 to control at least one of the web speed and actuation of the laminating adhesive applicator 206 to apply the laminating adhesive 207 in the correct spaced relation to the insulating material 110 on the substrate 102. When the registration mark 209 is printed on the first substrate 102 prior to the application of the insulating material 110, the registration mark 209 may be used to register the application of the insulating material 110, as well as the application of laminating adhesive 207. The registration mark 209 may also be used for registering the application of the second substrate 202 to the first substrate 102, such as when the laminating adhesive 207 has been applied to the second substrate 202 rather than the first substrate 102 on which the insulating material 110 is disposed, as shown in the process of FIG. 1C. The registration mark 209 may also be a printed pattern. Alternatively, the registration mark may be omitted if other methods can be used to register the laminating adhesive 207, insulating material 110, and any printed graphics together.

In a preferred embodiment, the laminating adhesive applicator 206 applies adhesive 207 around the insulating material 110 and following the peripheral edges of one of the substrates 102, 202 that form the blank 500/800. For example, as shown in FIG. 5A, the adhesive 207 is applied around the perimeter of the first substrate 102 of the blank 500 so as to form an air cushion, pillow, or air pocket when the second substrate 202 is applied to the first substrate 102 with the insulating material 110 sealed therein. The insulating material 110 is spaced apart from the lateral side edges 509, 511 and top and bottom edges 515, 516 of the first substrate 102 of blank 500 so that the laminating adhesive 207 can be applied without overlapping any insulating material 110. The width of the laminating adhesive 207 may be between ¼-3 inches wide, and is preferably 2 inches. In another form, as shown in FIGS. 8A-C, the adhesive 207 forms a continuous border 803 surrounding the applied pattern of insulating material 110 and substantially follows the contours of the edges of the blank 800 to extend around its perimeter 802, such that when the second substrate 202 is bonded to the first substrate 102, an air cushion, pillow, or air pocket is formed with the insulating material 110 being sealed within the pocket. Accordingly, the laminating adhesive 207 forms an insulation barrier and reduces the likelihood of insulating material 110 escaping the bag 600 or insert 700 between the two substrates 102, 202 and coming into contact any bag contents, such as food products stored in the bag 600, or food products placed on or near the insert 700.

As shown in FIG. 2, once the laminating adhesive 207 is applied to the first substrate 102, the first substrate 102 and the second substrate 202 are pressed together by rollers 204 to form a laminate 205 with the insulating material 110 sandwiched therebetween and the laminating adhesive 207 extending substantially therearound. Although the insulating material 110 is only bonded to the first substrate 102, the process could be modified so that the insulating material 110 is bonded to either or both substrates 102, 202.

In a preferred embodiment, the insulating material 110 applying machine line 100 and the laminate making machine line 200 are combined into a single line or system as shown in FIGS. 1B and 1C. In these processes, the process of applying slip film 116 is eliminated from the machine line 100. Additionally, the first substrate 102 is not rewound after the insulating material 110 is applied. Instead, as shown in FIG. 1B, the laminating adhesive 207 is applied onto the first substrate 102 having the dried insulating material 110 by the adhesive applicator 114, which is subsequently laminated with the second substrate 202 to form the laminate 205. Other than these differences, the process of FIG. 1B is identical to the process of FIG. 1A.

The process of FIG. 1C is similar to the process of FIG. 1B, except for a few additional variations. First, the first substrate 102 does not have a water barrier coating as in the processes of FIGS. 1A and 1B, as the first substrate 102 is used to form the outer ply of the bag 600 or the bottom, non-food contact surface of the insert or pad 700. The first substrate 102 is unwound from roll 105 and fed through a printer, such as a flexographic press 120 having a plurality of printing decks 121, 122. The first printing deck 121 applies a registration mark 209 in a predetermined location to the first side 101 of the first substrate 102 as described above. The registration mark or marks 209 may also be printed along one lateral edge 509, 511 of the substrate 102 or 202. In one form, the registration mark 209 is repeated every 25.25 inches in an embodiment for forming a bag 600 from the laminate 205, although this distance will vary depending on the desired end product. Printing deck 122 can be used to control and sync the substrate 102 as it is fed to the insulating material applicator 106, where insulating material 110 is applied to the substrate in predetermined locations on the substrate 102 using the registration mark 209. The insulating material applicator 106 applies the insulating material 110 to the first side 101 of the first substrate 102 as discussed above. The other distinction of the process from that of FIG. 1B is that the second substrate 202 includes a water barrier coating on a first side 201, as the second substrate 202 is to be used as the food contacting surface of the end product. The laminating adhesive 207 is applied to the second non-coated side 203 of the second substrate 202 by a laminating adhesive applicator 206 prior to lamination with the first substrate 102. The laminating adhesive 207 is applied in a predetermined pattern, such as the border pattern shown in FIGS. 5A and 8A. The first and second substrates 102, 202 are then laminated together at laminating machine 200. The laminating machine 200 may use an optical sensor to recognize the registration marks 209 printed on the first substrate 102 for registering the laminating adhesive 207 on the second substrate 202 with the dried insulating material 110 on the first substrate. A printer may also be used to print registration marks on the second substrate 202 at predetermined locations for assisting with proper registration of the two substrates 102, 202 at the laminating machine 200. An additional distinction from the process for FIG. 1B is that the laminate 205 is fed through a printer 208, such as a flexographic press, for printing graphics, logos, trademarks, or other information on the second surface 103 of the first substrate 102, which in the case of the bag 600, forms the outer surface 618 of the bag 600. The printed laminate 205 may then be wound up on a roll 218 as in the process of FIG. 1B.

In each of the processes described, the laminate 205 can be rolled or cut into sheets in order to be stored and/or transported to another machine line in order to be formed into final products, such as the bag 600 or the insert 700. Alternatively, the laminate 205 can be conveyed directly into a machine line for producing a final product so that there is a single, continuous process for forming the laminate 205 and a product therefrom.

To form a bag 600, the laminate 205 is fed into a bag making machine line 300. A seam adhesive applicator 308 applies seam adhesive 309 (see FIG. 5B) to the laminate 205 at glue seam 315 along the overlap section 581 of the blank 500. The seam adhesive applicator 308 can be any of the types of adhesive applicators listed above. In a preferred embodiment, the seam adhesive applicator 308 is a nozzle applicator. In the preferred embodiment, the seam adhesive 309 is an aqueous based adhesive so that it sets quickly. In one form, the seam adhesive is Aquence® CORE 3160UV available through Henkel Corporation.

The blank 500 in FIG. 5B shows the lines along which the laminate 205 is folded to make a bag 600 and the location of the glue seam 315. The glue seam 315 adhesive 309 width is between ½-2 inches and preferably 1 inch wide. The fold lines of the bag 600 include four outside vertical fold lines 502, a portion of which form the outer corners of the bag 600, two inside vertical fold lines 503, which allow the bag 600 to be folded flat and are located respectively between adjacent rectangular upper end panels 582a and 582b and between adjacent rectangular upper end panels 592a and 592b that in part form the collapsible sides 612, 616 of the bag 600. Horizontal bottom fold line 504 forms the bottom edge of the bag 600 and horizontal collapsing fold line 505 allows the bottom of the bag 614 to be collapsed and folded over one side of the bag 610. Diagonal bottom fold lines 597 extend between triangular panels 583a, 583b and trapezoidal bottom panel 593, and diagonal collapsing fold lines 587 extend downwardly from the intersection of the horizontal collapsing fold line 505 and the inside vertical fold line 503 on each of the end sections 582a, 582b and 592a, 592b, which allow the bag 600 to be folded flat. Horizontal closing fold line 508 extends across the upper front, upper rear, and upper end panels 598a, 588a, 582a, 582b, 592a, and 592b, and is spaced from the top edge of the blank 515.

In the bag making machine line 300 shown in a schematic representation in FIG. 3A, a series of rollers, protrusions, and/or rails 310 fold the laminate 205 in on itself about each of the outside vertical fold lines 502 such that the overlap portion 581 of the blank 500 is bonded to the opposite lateral side of the blank 500, including the sections 598a, 598b, 593, and 583b with the seam adhesive 309 as it is advanced along the machine line to form a rectangular tube 320. A cutter 312 cuts the rectangular tube into proper length blanks 500. In an alternative embodiment, the cutter 312 is positioned before the rails 310 so as to cut the laminate 205 into blanks 500 before folding. The cutter 312 may be a roll cutter 312 including circumferentially spaced cutting blades 332 as shown or a die cutter.

The bottom adhesive applicator 313 applies bottom adhesive 311 to the end panel bottom portions 586a, 586b, and 596a, 596b as well as to the bottom corner portions 583a, 583b on the side of the blank 500 that forms the outer surface of the bag 618, as shown in FIG. 5B. In one form, the bottom adhesive is Aquence® BG 096A available through Henkel Corporation. To form the bottom of the bag 614 shown in FIG. 11, the end wall panel bottom portions 586a, 586b and 596a, 596b are folded inward about the horizontal bottom fold line 504. The diagonal bottom fold lines 597 permit the first side wall panel bottom corners 583a, 583b to fold inward with the end panel bottom portions 586a, 586b and 596a, 596b. The trapezoidal first sidewall bottom central portion 593 folds inward to cover, or partially cover, the end panel bottom portion 586a and 596b. The second sidewall bottom portion is split into a rectangular central portion 589 and edge portions 591 by slits 590 that form the outer lateral edges of the rectangular central portion 589. The edge portions 591 fold inwardly and orthogonal to the end walls 612, 616 of the opened bag 600 along with the end panel bottom portions 586a, 586b and 596a, 596b, and then the central portion 589 folds down last to cover, or partially cover, the end panel bottom portions 586a, 586b and 596a, 596b and the first sidewall bottom central portion 593.

During the bag making process, inside vertical fold lines 503 are formed in the rectangular tube 320, and in the formed bag are located between the end sections 582a and 582b, and 592a, and 592b to aid in collapsing the bag 600 to a flattened state once formed. The inside vertical fold lines 503 extend from the top of the blank 515 to at least the horizontal collapsing fold line 505 of the finished bag 600. Near the bottom of the end sections 582a, 582b, 592a, 592b, two diagonal collapsing fold lines 587 extend towards what will be the bottom corners of the end walls 612, 616 once the bag 600 is formed. The fold lines 503, 587 enable the end walls 612, 616 to be folded into the center of the bag 600 such that the finished bag 600 can be folded flat. The sidewall sections 588a, 588b, 598a, 598b and the end sections 582a, 582b, 592a, 592b include a horizontal collapsing fold line 505 about which the bottom 614 can be folded when the bag 600 is folded flat. As described above, the bottom portions of the blank 586a, 586b, 589, 596a, 596b, and 593 are folded in on themselves by folders 314 to form the rectangular tube 320 into a bag 600.

After the bag 600 is formed from the blank 500, it is passed around a roller 318 under pressure in order to flatten the bag 600 and in some embodiments activate the pressure sensitive adhesive. The roller 318 holds all of the seams under pressure so that the seam adhesive 309 can set fully. The roller 316 also fully flattens the bags 600 so that they take up a minimum amount of space for storing and/or transporting.

The bags 600 can be stored for an extended period of time with the insulating material 110 in a dormant state. Keeping the insulating material 110 in a dormant state enables the bags 500 to be stored and/or shipped while taking up less space than they do once the insulating material 110 is activated.

In some embodiments, the amount by which the insulating material 110 expands upon activation may be reduced the longer the insulating material 110 is kept in a dormant state. The amount of insulating material 110 applied by the applicator 106, or the amount by which the insulating material 110 is pre-activated by the heater 112 can be adjusted in order to compensate for planned extended lengths of storage in a dormant state.

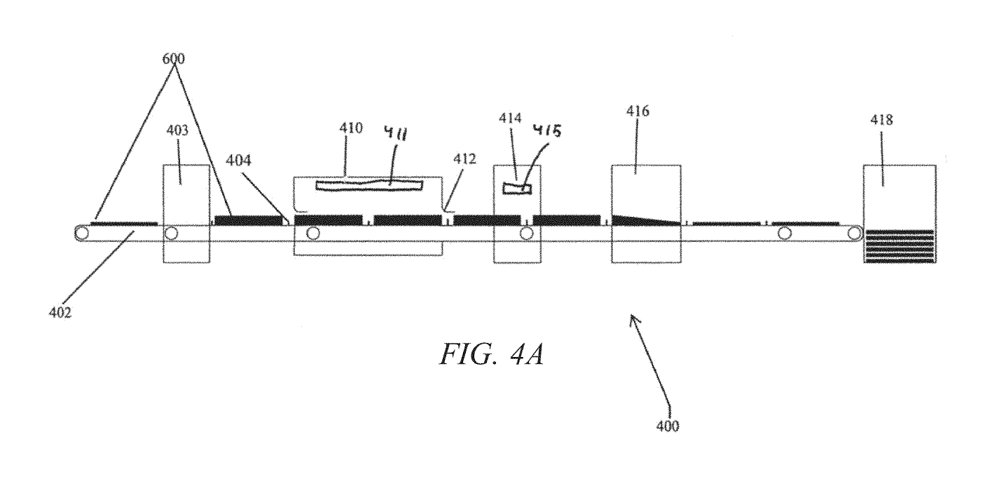

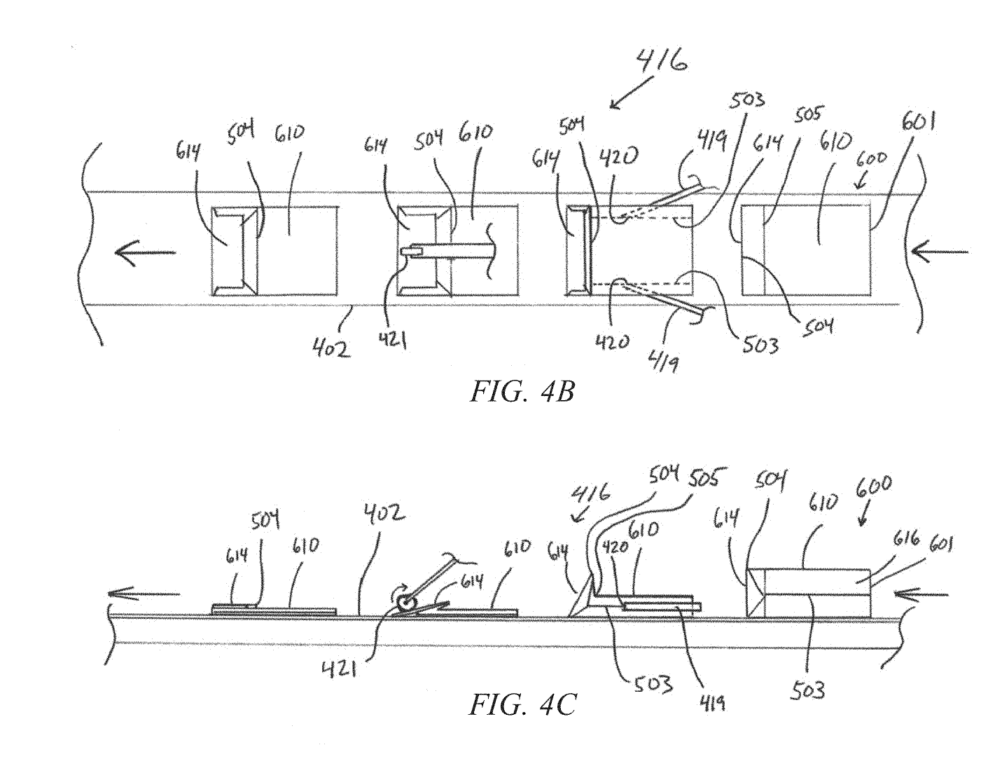

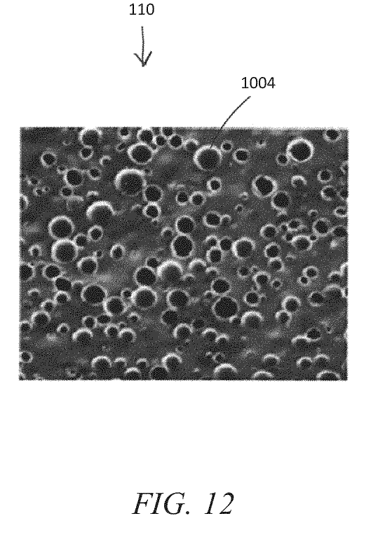

In order to fully activate the insulating material 110 so that the microspheres are fully expanded, heat is applied to the finished bag 600 in a thermal insulation activation machine line 400. In one form shown in FIG. 4A, the bag 600, starting on the left-hand side of FIG. 4A, is opened or expanded by a bag opening station 403 prior to heating the bag 600. Expansion of the bag 600 aids in the even application of heat to the insulating material 110. If the bag 600 were heated when in a collapsed state, the insulating material 110 in areas with fewer material layers, such as central portions of the side walls 610 that do not overlap with the folded in end walls 612, may become over-expanded while the insulating material 110 in areas with more layers, such as the center portions of the end walls 612, may be under-expanded. Overexpansion of the microspheres in the insulating material 110 can lead to the microspheres 1000 rupturing. Preferably, the expanded insulating material 110 contains only non-ruptured microspheres (see FIG. 12), although a small amount of ruptured microspheres is acceptable so long as the resulting thickness of the expanded insulating material 110 is not adversely affected and the insulating material 110 remains a closed-cell foam structure such that the gas-filled cells are discrete and completely surrounded by solid material.

A number of different methods can be used to expand the bags 600. In a preferred embodiment, the bag opening station 403 includes vacuum lines are used to grip either bag side wall 610, 615 and pull the side walls apart causing the end walls 612, 616 to unfold along the crease 503. Preferably the bag 600 is only partially opened, i.e., with the top opening 602 smaller and side walls 610, 615 closer together than when the bag is fully opened, so that it is easier to collapse the bag again after post-activation or heating. In alternative embodiments, the bag opening station 403 expands the bags 600 by directing air flow into the mouth 602 of the bag 600 such that the pressure differential expands the bag.

Once the bags 600 are opened, they are fed, either vertically or horizontally with one side 610, 615 of the bag laid down, to a heating station 410 which is heated by a heater 411, such as a convection oven or microwave heater. The bags are carried into the heating station 410 by a conveyor belt 402. Laterally extending fins 404 define spaces that are slightly larger than the height of the bags on the conveyor belt 402 on which bags 600 are placed. The fins 404 keep the bags 600 from sliding around on the conveyor belt 402 as a result of air currents or from contacting the flaps 412 of the heating station 410. The heater 411 can be one of a variety of heaters including convection, conduction, radiation, microwave, or infrared. In some embodiments, the heater 411 employs a combination of heating methods. In one preferred embodiment, the heater 411 is a hot air heater or convection heater. The temperature of the heater 411 varies based on the speed of the conveyor belt 402. The faster bags 600 move through the heater 411, the higher the temperature needs to be in order to fully activate the microspheres. In one form, the conveyor 102 advances the bags 600 through the heating station 410 at a rate of 5 to 200 bags per minute. In one preferred form, the insulating material 110 is heated to a temperature between 200 degrees Fahrenheit and 250 degrees Fahrenheit in order to activate the microspheres. In a more preferred form, the insulating material 110 is heated to between 225 degrees Fahrenheit and 231 degrees Fahrenheit. Heating of the insulating material 110 to a temperature above 250 degrees Fahrenheit may cause over expansion and rupturing of the microspheres. The oven temperature is set at a higher temperature than the target temperature of the insulating material in order for the insulating material to reach its target temperature. In another preferred form, the temperature of the heater 411 is set between 330 degrees Fahrenheit and 450 degrees Fahrenheit. Once fully expanded, the thickness of the insulating material 110 is 10-60 times thicker than in an unexpanded form or, in a preferred embodiment, 20-40 times thicker.

In some embodiments, the heater directs heat directly to each wall of the bag 600. Hot air nozzles, microwave emitters or waveguides, or infrared heaters can be built into the ceiling, conveyor frame, and guide rails of the heater 410, each being directed towards the bags 600.

The heater 411 may include rubber flaps 412 at both the inlet and the outlet. The rubber flaps 412 are configured and sized to lessen the hot air flow out of the heater 411 from the entrance opening and the exit opening. In particular, the flaps 412 together should cover at least a majority of the inlet and outlet openings of the heater, and preferably at least 75 percent of the inlet and outlet openings. This reduced air flow enables the heater 411 to maintain an elevated working temperature with less energy.

After the insulating material 110 is fully activated by the heater 410, the bags 600 may then be conveyed to a cooling station 414 and into a cooler 415. The cooler 415 may operate by directing cool air towards the bags. The cooler 414 rapidly reduces the temperature of the bags 600 and the insulating material 110 so that they can be handled more comfortably and so that the insulating material 110 stops expanding. In alternative embodiments, the cooling station 414 may be removed.

The cooled bags 600 are then collapsed by a bag collapser 416. As shown in FIGS. 4B and 4C in one form, the bag collapser 416 comprises two side folding protrusions, one on either side of the bags 600, configured to push in on the creases 503 as the bags 600 are being advanced downstream by the conveyor belt 402 in the machine direction. For example, the side folding protrusions may take the form of opposed rods 419 on either side of the conveyor belt 402 that each extend inwardly toward one another above the conveyor belt 402 such that distance between the rods 419 decreases in the machine direction, and at their closest point near the distal ends 420 have a dimension that is smaller than the width of the bag 600 between the end walls 612, 616 when the bag is completely expanded. As a bag 600 is conveyed downstream, the distal ends of the rods 419 will engage the bag 600 on either bag side 612, 616 at or near the creases 503, pushing each crease inwardly toward the other crease. The rods may be biased towards the center of the conveyor 402 and be configured to articulate outwardly away from the center of the conveyor from the position shown in FIG. 4B to allow the bottom of the bag 614 to pass before articulating back towards the center of the conveyor 402 to engage the sides 616, 612 of the bag. Once the creases 503 are pushed in a bottom folding protrusion, such as a rod, flap, or roller 421 located above the conveyor 402 and extending downwardly toward the conveyor, folds over the bottom of the bag 614. This is accomplished by contacting the bottom of the bag 614 as the bag 600 is advanced downstream by the conveyor belt 402 such that the bottom of the bag 614 is forced to fold over into a collapsed orientation in order to pass by the protrusion or roller 421. In alternative embodiments, the bottom folding protrusion is replaced by an articulating pusher rod that allows the front edge of the bottom of the bag 504 to pass before pushing downwardly on the front wall 610 near horizontal collapsing fold line 505 to cause the bag to collapse. In addition, where the bag 600 is only partially expanded, collapsing of the bag may be accomplished solely by the side folding protrusions or rods 419, or alternatively by the bottom folding protrusion. Although the side folding protrusions and bottom folding protrusion are shown in FIGS. 4B and 4C as being spaced apart in the machine direction so as to operate separately on each bag 600, they could be located closer together to engage with a single bag simultaneously.

The flattened bags 600 can then be packaged for shipping with a packing station 418. The elastic qualities of the insulating material 110 allow the bags 600 to be partially compressed for shipping. Once the bags 600 reach their destination, the bags 600 are unpacked to allow the insulating material 110 to bounce back to part of its full expanded volume up to near its full expanded volume.

In an alternate embodiment for forming insulating sheets, pillows, or pads or inserts 700 instead of bags 600, the laminate 205 containing inactivated or partially activated insulating material 110 is conveyed into the insert making machine line 350, as shown in FIG. 3B. The laminate 205 includes insulating material 110 applied in a pattern of spaced apart small rectangular areas 111 positioned in an array, such as shown in FIGS. 8A-8C, although a variety of patterns and shapes, including a continuous layer or a randomized pattern could be used as discussed above. At the beginning of the process shown in FIG. 3B, a laminating adhesive 207 has already been applied to one of the substrates 102, 202 such that it surrounds the insulating material 110 to form enclosed or sealed air cushioned pockets. A cutter 352, such as a die cutter or a roll cutter, cuts the laminate 205 into pads or inserts 700. The cut is made around the insulating material, not through it, typically through the adhesive bonded area. The insert 700 may take on any of a variety of shapes, depending on the desired application. In the disclosed form shown in FIG. 7, the insert 700 is shaped to fit within a pizza box having a generally square shape and a trapezoidal portion extending from the front edge of the box. Insert 700 includes a rear edge 706, opposite first and second side edges 708, 710 that extend orthogonally from the rear edge 706, and a trapezoidal portion 704 extending from the front edge 712 corresponding with trapezoidal portion of the pizza box. With the insert 700 received in the pizza box and a freshly made hot pizza thereon, the insert 700 is operable to insulate the underside of the pizza. The insert 700 is shaped to have generally the same size and shape as the bottom of the pizza box or food container such that it does not shift around within the container and such that it insulates substantially all of the food from the bottom wall of the food container. In other words, rather than sitting directly on the container bottom wall, the pizza will now rest on the upper surface 702 of insert 700 which insulates it from the bottom wall which is exposed to the outside ambient temperature. Due to the spaced-apart pattern of the adhesive and the flexibility of at least one of the substrates 102, 202 that forms the food contacting surface of the laminate 205, the food contact surface 702 may have an undulating or non-flat configuration for contacting a food product that includes air flow channels to enable moisture or steam to escape easily from the food product in contact with the food contact surface to help keep the food product from becoming soggy due to absorption of steam or moisture condensation. Alternatively, the laminate 205 could be formed with a single face corrugate to provide air flow channels between the flutes of the corrugate. The air flow channels will allow steam or hot moisture from the pizza to escape easily, and keep the pizza crust from being soggy.

The insert in accordance with the disclosed forms is capable of keeping food products, such as pizza, warmer than conventional cardboard inserts. For example, a pizza with a starting temperature of 200 degrees Fahrenheit is placed within a pizza box on top of the insert 700. After 20 minutes in a standard ambient temperature environment, e.g., 70 degrees Fahrenheit, the pizza can be kept above at least 150 degrees Fahrenheit, and 20 degrees Fahrenheit warmer than an identical pizza with the same starting temperature placed in a standard pizza box without an insert 700.

After the insulated laminate 205 is cut into the desired shape of the inserts 700, the inserts 700 are then conveyed to a heating station 354 and into a heater 355, as shown in FIG. 3B. As with the heaters described above with respect to the bag making process, the heater 354 can be any type of heater including convection, conduction, radiation, microwave, or infrared. In some embodiments, the heater 354 employs a combination of heating methods. In one preferred embodiment, the heater 354 is a hot air heater or convection heater. The temperature of the heater 354 varies based on the speed at which the inserts 700 are conveyed through the heater 354. The faster the inserts 700 move through the heater 354, the higher the temperature needs to be in order to fully activate the microspheres. In a preferred form, the temperature of the heater 354 is between 330 degrees Fahrenheit and 450 degrees Fahrenheit. Heating of the insulating material 110 to a temperature above 450 degrees Fahrenheit may cause over expansion and rupturing of the microspheres. Once the insulating material 110 is fully expanded, the thickness of the insert 700 is 0.1 inches to 0.5 inches. Alternatively, the insulating material 110 can be fully expanded prior to cutting the laminate 205 into individual sheets or inserts 700.

Once the insulating material 110 is fully activated, the inserts 700 are packaged at a packing station 356. As with the bags 600 above, the elastic qualities of the insulating material 110 allow the inserts 700 to be compressed for shipping.

In an alternative embodiment, the heating station 354 and the heater 355 thereof is removed from the machine line 350. The inserts 700, or other finished products such as bags 600, are packaged and shipped without the insulating material 110 being fully activated. A heating station 354 can then be used at a remote location, such as a regional distribution center or at the end user's facility, such as a restaurant, to fully activate the insulating material 110. In a still further alternative, the insulating material 110 can be fully activated by the heat of the food product in the final container if the food temperature is hot enough.

In some embodiments, the thickness of the insulating material 110 applied by the applicator 106 and/or the amount of activation caused by the heater 410 or 354 are adjusted based on how long the bags 600 or inserts 700 are to be stored and/or shipped in a compressed state. The longer the bags 600 or inserts 700 are compressed, the less they tend to re-expand when released. Thus, bags 600 or inserts 700 that will be compressed longer can be made with more insulating material 110 or insulating material 110 that has been expanded to a greater degree in order to achieve the same final post-shipping and post-storage thickness. The amount by which compression reduces the thickness of the insulating material 110 can further be reduced by cooling the insulating material 110 prior to compression.

In some embodiments, the insulating material activation machine line 400 is located at a satellite site near where the end products will be used. By placing an insulation activation machine line at multiple locations throughout the country and/or throughout the world, the end products can be shipped in an unexpanded state in order to save on shipping costs. The end products may even be activated at the site of the end user.

In alternative embodiments for forming a bag 600, the activation machine line 400 is combined with the bag making machine line 300 to form a single, continuous line. In such a process, the roller 318 shown in FIG. 3A finishes forming the bags 600 and then feeds the bags 600 directly onto the conveyor 402 shown in FIG. 4A. In still further alternatives, the insulating material 110 is activated in the middle of the bag forming machine line 300. The heater 410 is placed between the folders 310 and the roller 318. This way the bag 600 is heated in order to activate the insulating material 110 before the bag is collapsed, removing the need to expand it before heating.

In additional alternative embodiments, all the machine lines 100, 200, 300/350, 400 are combined into a single continuous machine line. The first and second machine lines 100, 200 are combined as described above with the second machine line 200 feeding directly into one or both of the product forming machine lines 300/350. Additionally, the insulation activation machine line 400 can be integrated into the bag forming machine line 300 in any of the ways previously described.

The single, continuous machine line may utilize microwave heating. In this case, the insulating material 110 applied by the applicator 106 may be activated while the insulating material 110 is still wet. Accordingly, the drying heater 112 may be removed, and the insulating material 110 remains wet until activation. The activation heating stations 410/354 are replaced with industrial microwave heaters. The water in the insulating material 110 converts the microwave energy into thermal energy, causing activation/expansion of the microspheres. In some forms the insulating material 110 for microwave activated applications has a viscosity of between 2,000 and 6,000 centipoise at room temperature, i.e., 72 degrees Fahrenheit. In a preferred form, the insulating material 110 has a viscosity of between 3,000 and 4,500 centipoise at room temperature. In one example the insulating material 110 used is Aquence® ENV 42001 MFA available through Henkel Corporation.

In an alternative embodiment, microwave heatable materials other than water are included in the insulating material 110 so that the insulating material 110 can be dried by the heater 112 and stored in a dormant state without sacrificing the ability to activate by microwave later in the process. Exemplary substitute materials include ionic salts and carbon black.

In an alternative embodiment, the insulating material 110 is fully activated by the heater 112 prior to forming the laminate 205. The laminate making machine line 200 forms a laminate 205 using a first substrate 102 having the fully activated layer of insulating material 110 and the second substrate 202. The bag making machine line 300 then folds and glues that laminate 205 into a bag 600 and/or the insert making machine line 350 cuts the laminate 205 into inserts 700 without the need for subsequent heat activation of the insulating material.

In still further alternative embodiments, the insulating material 110 is activated after the laminate 205 is formed but before the laminate 205 is made into final products, such as bags 600 or inserts 700. An inline heater similar to the heater 112 is placed after the laminating adhesive applicator 206 in the laminate forming machine line 200. The new heater fully activates/expands the microspheres in the insulating material 110.

A printer 208 may be added to one of the machine lines 100, 200, 300, 350, 400 in order to print labeling, trademarks, or other information onto the bags 600 and/or inserts 700. The printer can be implemented at any point of the process. In a preferred embodiment, the printer is not placed immediately before or after a heater so that the ink has time to set at ambient temperatures. In a preferred embodiment, the printer is integrated after the substrates 102, 202 are cut into blanks 500 or inserts 700 and/or folded into bags 600 to reduce the chance of the printed mark being out of alignment on the end product.

In some embodiments, the pattern of insulating material 110 is configured such that the total percentage of the end product by weight that is insulating material 110 is low enough for the end product to be recyclable and/or repulpable. In further embodiments, the insulating material, various adhesives, and barrier coating may be composed of compostable materials, such as starch, so that the end product is compostable.

FIG. 6 illustrates a finished insulated bag 600 formed in the machine lines 100, 200, 300, and 400 described above. The bag 600 comprises flexible front and rear sidewall 610, 615 and two opposing flexible end walls 612, 616. The end walls 612, 616 are divided by fold line or crease 613. The top of the bag 601 has an open mouth 602 formed by the upper edge of the sidewalls and end walls 610, 615, 612, 616. Once the bag 600 is loaded, the upper portion 611 can be folded or rolled down in order to close the bag 600. A piece of adhesive tape or the like can be applied across the folded-down top and also to the side walls 610 to keep the bag 600 folded and closed. In this manner, the volume or space in the bag interior 617 is adjustable to the contents of the bag 600 by adjusting how much the upper portion of the bag 611 is folded down. In one form, the insulating material 110 is not applied near the mouth 602 in the area of the bag that will be folded or rolled over. Accordingly, the bag 600 includes an upper uninsulated portion 611 on each side 610 and end wall 612 that is suitable to be rolled up for closing the bag. The laminating adhesive 207 can be applied in a thicker band in the upper uninsulated portion 611 because of the absence of insulating material 110, can be applied in multiple bands, or can still be applied only at the edge of the blank 500.

In one form, the bag 600 has a footprint size, or dimensions of the bottom wall 614, when expanded of about 11.5 inches by 7 inches and a height of its upstanding side and end walls 610, 615, 612, 616 of about 20 inches. In some embodiments, there are horizontal creases 505 on the sidewalls and end walls 610, 615, 612, 616 roughly 3.5 inches up from the bottom along which the bag 600 is folded when collapsed into a flattened state. In still further embodiments there are horizontal creases 508 in the sidewalls and end walls 610, 615, 612, 616 roughly 3 inches down from the mouth 602 about which the top can be folded and then sealed (e.g., with a sticker, tape, and/or staples). The uninsulated portion 611 includes the top 7 inches of the bag 600. However, many different shapes and sizes of bags 600 are contemplated.

In operation, the insulated bag 600 is intended to be used to store perishable items, such as cold groceries at or below a threshold temperature during transportation and/or delivery. In an exemplary operation, the insulated bags 600 can be used to deliver groceries, enabling the groceries to be left outside at the recipients' door for hours in summer conditions while minimizing the possibility of frozen food thawing or refrigerated food from becoming dangerously warm.

For example, the bag 600 with the insulating material layer 110 having an expanded thickness of 0.2 inches once activated can meet certain performance characteristics. For example, a bag, having a height of twenty inches prior to closing the bag, filled with a half-gallon milk container and two 5.3 oz. yogurt cups starting at a temperature of 36 degrees Fahrenheit with the bag upper area 611 rolled down 3 inches to a closed height of seventeen inches was able to keep the rise of temperature of milk and yogurt to less than 30 degrees Fahrenheit at an ambient temperature of 85 degrees Fahrenheit for 3.5 hours without the aid of any additional chilling via ice packs or dry ice. At an ambient temperature of 110 degrees Fahrenheit, the bag 600 can keep the increase in the temperature of the milk and yogurt starting at a temperature of 36 degrees Fahrenheit to less than 30 degrees Fahrenheit for an hour without the aid of any additional chilling via ice packs or dry ice. The bag 600 keeps the rise of temperature of the same milk and yogurt starting at 36 degrees Fahrenheit to less than 30 degrees Fahrenheit at an ambient temperature of 93 degrees for 1.15 hour, and then 110 degrees Fahrenheit ambient for 2.15 hours in a total 3.5 hour time frame with the aid of 2-3 lbs of chill packs of ice.

In another example, the bag 600 keeps the rise of temperature of a half-gallon container of ice cream and one pound bag of frozen fruit starting at a temperature of zero degrees Fahrenheit to less than 20 degrees Fahrenheit at ambient temperatures of 85 degrees Fahrenheit for 3.5 hours without the aid of any additional chilling via ice packs or dry ice. At an ambient temperature of 110 degrees Fahrenheit, the bag 600 can keep the increase in the temperature of ice cream and frozen fruit to less than 20 degrees Fahrenheit for an hour without the aid of any additional chilling via ice packs or dry ice.

In an additional example, when 400 grams of ice are placed in the bag 600, the upper portion 611 is rolled or folded to seal, and then the bag 600 is left in a 109 degree Fahrenheit environment some unmelted ice remains after 4 hours.

In some embodiments, the laminate 205 with fully activated insulating material 110 has an R-value ranging from 0.05 m2 K/W to 0.5 m2 K/W.

FIG. 7 illustrates a finished pad or insert 700 made by the machine lines 100, 200, and 350 described above. The perimeter of the insert 700 is shaped to fit into a standard pizza box. The insert 700 can be cut and made into a variety of shapes in order to conform to one or more of the panels that define the shape of the container into which the insert will be placed. A cutaway view of the insert 700 of FIG. 7 is shown in FIGS. 8A-8C with the second substrate 202 removed. FIGS. 8A-8C illustrate three (3) exemplary patterns of insulating material 110. In each pattern, the insulating material 110 is applied in rectangular areas 111. The pattern shown in FIG. 8A comprises rows of rectangular areas 111, with adjacent rows being offset in the same manner shown in FIG. 5A. FIG. 8B includes rectangular areas 111 of insulating material 110 arranged in concentric circles. The concentric circles are positioned so as to be centered on the center of the box into which the pad 700 will be inserted, such that the concentric circles of insulating material are concentric with any pizza placed on top of the insert 700. FIG. 8C illustrates a pattern comprising of both vertical and horizontal rectangular areas 110. The pattern is roughly circular in shape, and positioned such that it would be under substantially all of the pizza.

In some embodiments, an insert 700 can further include a moisture absorbent material, a phase change, and/or a heat releasing material or method. As described above one or both of these elements can be integrated with the insulating material 110. Alternatively, a layer of superabsorbent or desiccant material can be added to the insert 700 separate from the insulating material 110 or in place of the insulating material 110. Additionally, a layer of phase change material or heat releasing material can be included in the insert 700. The heat releasing material may simply be a phase change material that is a heat sink that absorbs heat and slowly releases it, such as sodium acetate, a phase change material that releases heat as it changes phases at a certain temperature, or a material that undergoes an exothermic reaction with steam or condensate, such as synthetic zeolite. If an absorbent material and/or a reactant are included in the insert 700 one or both substrates 102/202 may be perforated to allow steam and/or water to flow into the insert and interact with the absorbent or reactant material.

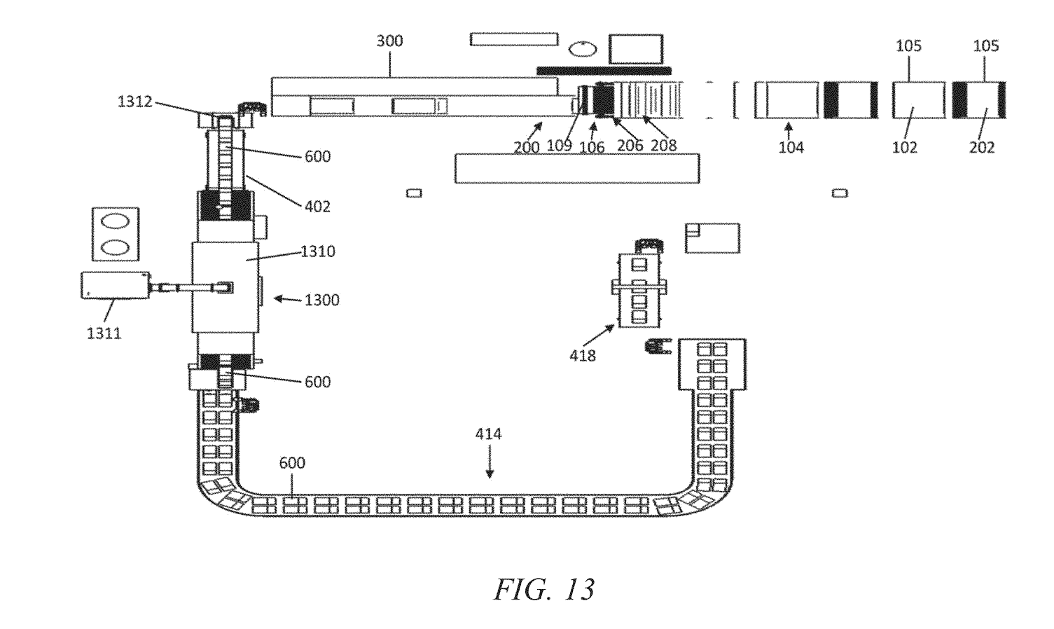

Another preferred form for forming an insulated collapsible bag 600 using a single, continuous machine line is shown in FIG. 13. As in previous embodiments, the process begins with first and second substrates 102, 202, which are dispensed from rollers 105. The substrates are preferably made of paper, such as kraft paper. As in the other disclosed processes, the first substrate 102 is fed by a series of rollers 104 to a printing station 208 for printing an outer design on the outer surface of the second substrate 202, which will end up as the outside facing layer of the finished bag. Subsequent to the printing station 208, a laminating adhesive applicator 206 applies adhesive 207 at laminating adhesive locations surrounding the area where the insulating material 110 will be applied and following the peripheral edges of the substrate 102 that forms the blank 500. The laminating adhesive 207 may be applied by conventional adhesive application equipment to one or both of the first substrate 102 and the second substrate 202. For example, as shown in FIG. 5A, the adhesive 207 is applied proximate to the perimeter edges of the first substrate 102 of the blank 500 to be formed from the unexpanded laminate such that the insulating material 110 will be surrounded by laminating adhesive 207 when the second substrate 202 is applied to the first substrate 102 at the laminating station 200 with the insulating material 110 sealed therein.

Once the bag 600 is formed, the laminating adhesive 207 keeps the insulating material 110 from escaping from between the substrates 102, 202 by sealing each edge of the bag. For example, in use, flexing of the bag 600 may cause insulating material bonded to one or both of the substrates to become loose and become free to move about within the walls of the bag. Accordingly, the laminating adhesive 207 may be applied to form a continuous perimeter about the insulating material 110 such that the bonded substrates form sealed edges around the insulating material. However, in some forms the adhesive 207 may be applied in a discontinuous manner in one or more locations if desired. In particular, it has been discovered that having a portion of the unexpanded laminate with an edge that is not completely sealed allows moisture to escape from between the substrates when the insulating material is heated, which allows for improved expansion of the insulating material. For example, the adhesive seam along the top edge 515 of the first substrate 102 of blank 500 (See FIG. 5A) may be discontinuous rather than continuous as shown. Preferably, the gaps between the adhesive should be small enough to keep any expanded insulating material from passing between the gaps in the adhesive and between the substrate portions. For example, the gap between adhesive locations may range from 0.25 inches to 2 inches, and more preferably, from 0.25 inch to 1 inch. In addition, due to the top portion of the blank 500 and resulting bag 600 being free from insulating material 110, it is less critical that the upper edge 515 be completely sealed to keep insulating material from escaping from between the substrates. In addition, because the bag is typically used in an upright manner, gravity assists in keeping any loose insulating material 110 from exiting from the upper edge 515 of the bag 600.

The first substrate 102 is then advanced in a machine direction to an insulating material applicator 106. In this embodiment, the applicator 106 is a series of nozzle applicators. The nozzle applicators apply the insulating material 110 in liquid form to a first side or surface 101 of the first substrate 102. The second side or surface 103 of first substrate 102 may be pre-treated with a water barrier coating. The insulating material 110 is an expandable insulating material activated by heating, such as Aquence® ENV 42001 MFA.

In one form, the nozzles are stainless or more preferably ceramic ribbon coat nozzles. As the first substrate 102 moves under the nozzle applicators, independently controllable valves connected with each nozzle applicator open intermittently to apply rectangular sections of insulating material 110 through the nozzle applicators. In one form, the insulating material 110 is applied in 1 inch×0.75 inch rectangles by each nozzle. The nozzles are arranged in one or more banks or rows, and preferably two separate rows. In one form for applying insulating material to form a flexible laminate that will be formed into a collapsible bag, one row includes 14 nozzles and 14 corresponding valves, and the second row includes 13 nozzles and valves, for a total of 27 independently controlled nozzle applicators. The each bank of nozzles is connected to a separate supply manifold which has its own pressure regulator, such that the insulating material 110 is supplied to each of the nozzles in a bank at substantially the same pressure. The nozzles in the second row are arranged to be offset from the nozzles in the first row so that two rows of nozzles apply insulating material 110 arranged in a pattern of individual spaced apart portions, such as rectangles, that are aligned in a plurality of columns. For example, a nozzle application system with 27 spaced apart nozzles applies insulating material aligned in 27 separate columns, with the individual portions of insulating material within a column spaced apart from one another. A plurality of rows of offset nozzles can be used to create tighter patterns. The nozzle application system can be sourced from the Valco Melton company. The substrate 102 is advanced by the conveyor system under the nozzles at a speed of between 150 and 250 feet per minute. In one form, the substrate 102 moves at a speed of approximately 200 feet per minute. A flow meter can be used to measure the volume of insulating material 110 applied by the applicator system to portion of the substrate that will be used to form a single bag. If the amount of insulating material, is outside of a predetermined range, the substrate can be marked to indicate a defect for later removal from the line, such as after the laminate has been formed into a bag.

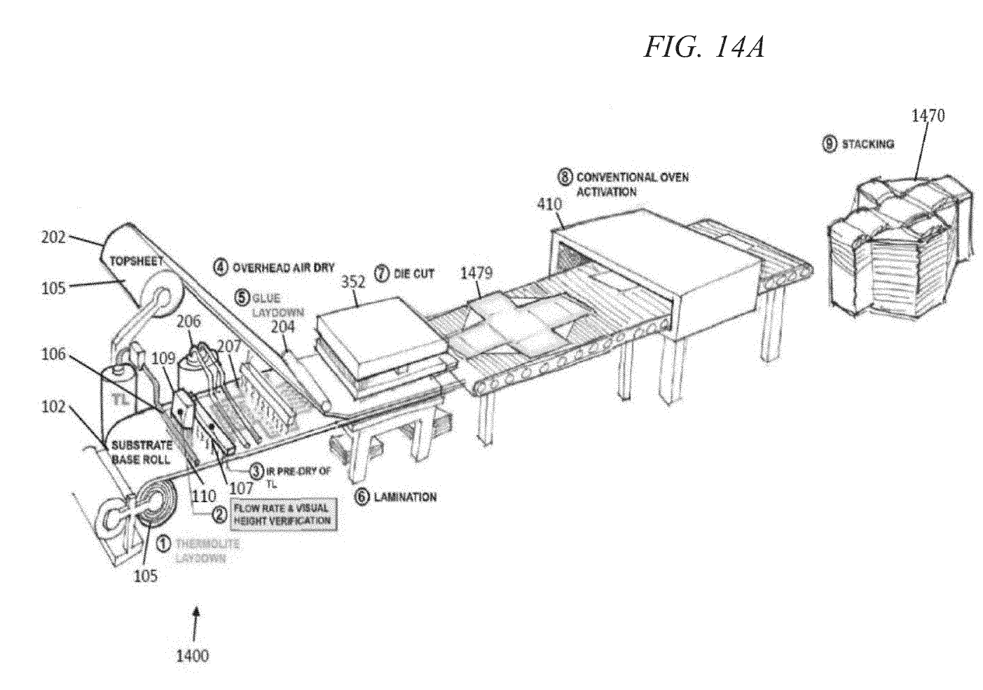

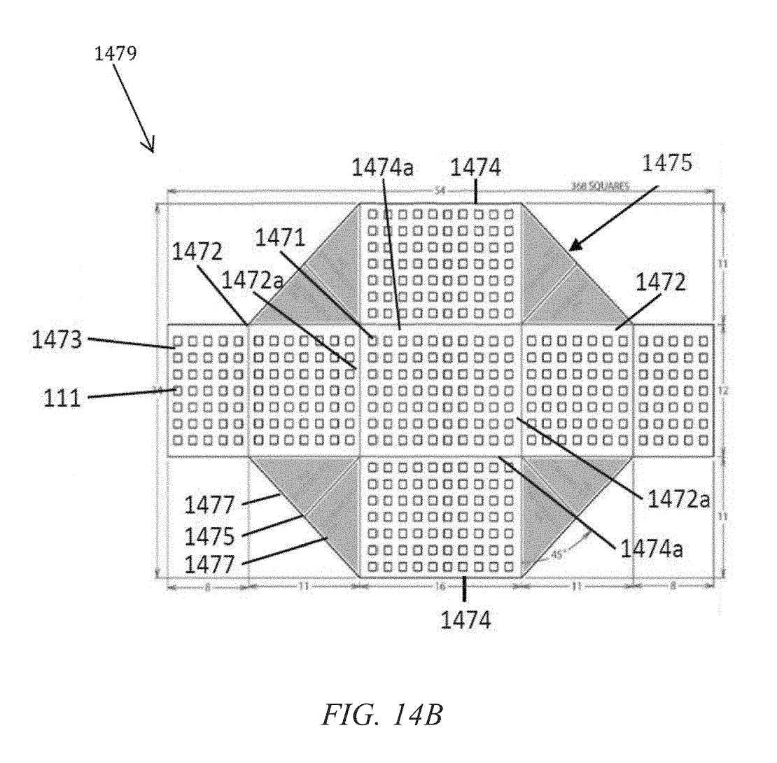

After the applicator 106, a vision system 109 (such as shown in FIG. 14A) is implemented to confirm the insulating material 110 has been properly applied. In one form, the vision system 109 comprises an optical sensor in the form of a line scan camera positioned downstream from the insulating material applicator 106 above the advancing first substrate 102 that outputs images of the applied insulating material 110 on the substrate 102 to a computer. The computer identifies the sections of insulating material 110 and compares them to the desired predetermined pattern to verify the applied insulating material falls within an acceptable range of accuracy, for example 90-100%. That is, the vision system verifies that the proper amount of the insulating material has been deposited at the desired points along the length of the substrate. If the visual inspection determines that a failure regarding insulating material placement has occurred, then a fault or warning signal is triggered, which can cause the machine system to slow down or stop, cause the substrate to be marked at the point of the failure, or simply notify a user of the issue. The fault signal can cause the nonconforming blank to be flagged for later removal from the forming system. In some forms, the blank formed from the substrate or substrates is physically flagged with a printer or marker so that a machine or a user can identify it and remove it from the line. An additional optical sensor could be used to measure the height of the applied insulating material as measured from the surface of the first substrate 102 to verify the desired amount of insulating material has been applied to the substrate, instead of, or in addition to measuring the amount of the insulating material applied by the applicator system using a flow meter as described above.

After the insulating material 110 is applied, the first substrate 102 and the second substrate 202 are bonded together via the previously applied laminating adhesive 207 at laminating station 200 using nip rollers to form an unexpanded laminate as previously described.

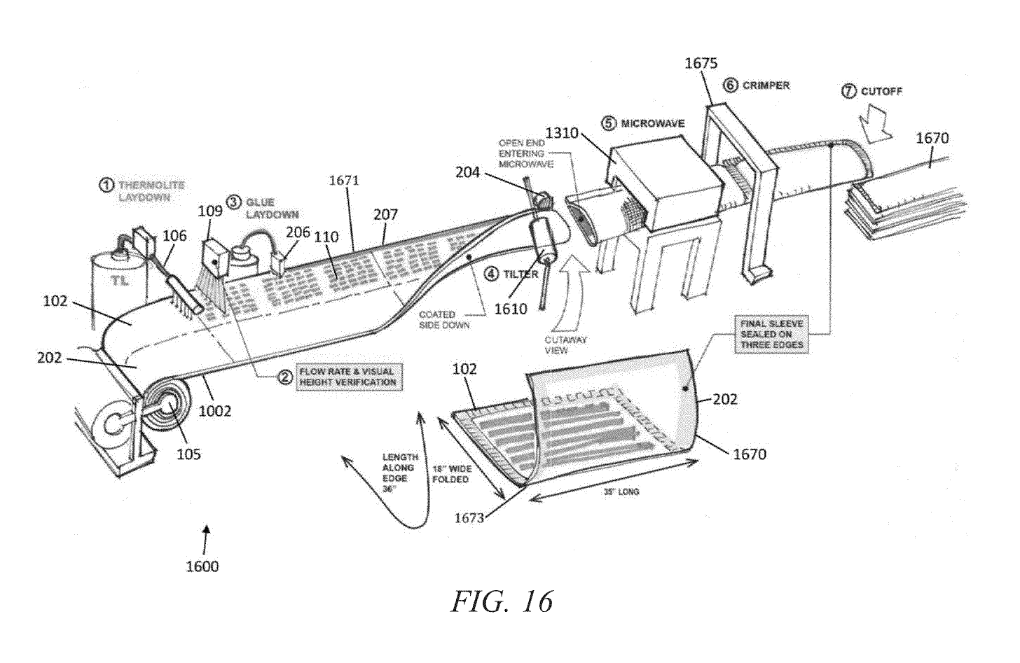

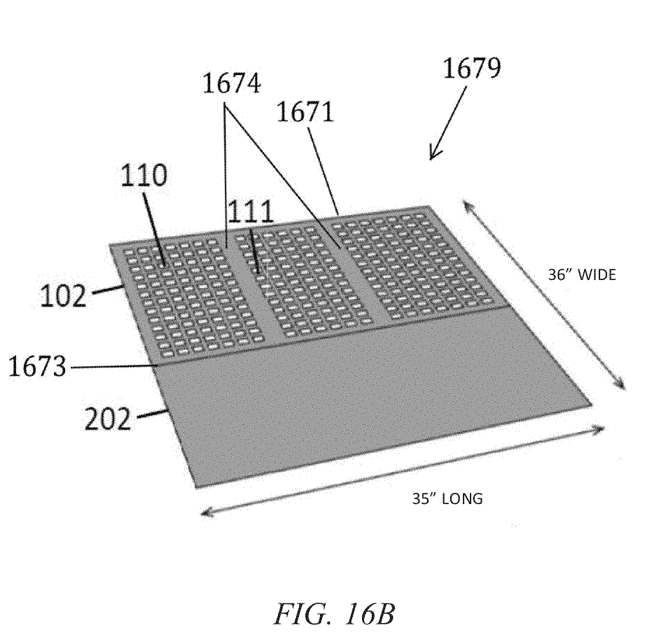

In some forms, the first substrate 102 and the second substrate 202 are two portions of a single ply or sheet 1602 of material, as illustrated in FIG. 16A. In such an embodiment, the laminating adhesive applicator 206 applies laminating adhesive 207 at laminating adhesive locations to one lateral side of the substrate 102 and insulating material applicator 106 the applies insulating material 110 to the substrate 102 at insulating material locations within the applied laminating adhesive 207, although the order of application of the laminating adhesive 207 and insulating material 110 could be reversed. The laminating adhesive 207 thus surrounds the insulating material 110 and is spaced therefrom, and the substrate is folded in half along longitudinally extending fold line 1673, sealing the insulating material 110 between the two ply portions that extend from the fold line 1673. This method of creating a two ply laminate out of one sheet of substrate 102 can be used in any of the embodiments described herein. The laminating adhesive 207 may be omitted from being applied along the fold line 1673, as the fold line provides a barrier to contain the insulating material.

After lamination, the unexpanded laminate is fed directly into a bag making system or converter 300. The bag making system 300 is described in greater detail above. The bag making system 300 outputs discrete, folded collapsible bags 600 with unexpanded insulating material 110 disposed within the base and walls of the bag. The bags 600 are then fed into a heating station 400 for activation. In some forms, the bags 600 are stored before being activated. In alternative embodiments, such as shown in FIG. 13, the bags 600 are fed directly into the heating station 1300 after forming using a bag feeder 1312, in which a plurality of bags may be loaded and which feeds individual bags 600 in a spaced apart manner onto the conveyor 402 for being fed into the oven 1310 for expanding the insulating material 110 within the formed bags 600. The gap between the bags 600 aids in heating the bottoms of the bags 600. In some forms the bags are spaced by ½ inches to 1½ inches. In this embodiment, the bags are heated in the collapsed orientation, omitting the bag opening and collapsing steps discussed in other embodiments of the bag-making process.

The oven 1310 includes a chamber with wave guides configured to direct microwaves from a microwave generator 1311 through the bags 600 being conveyed through the oven 1310. The microwaves cause the water, or other microwave sensitive material in the insulating material 110 to be heated to activate and expand the microspheres in the insulating material.

The heating station 1300 shown has a single port or wave guide connecting the microwave generator 1311 to the oven 1310. In alternative embodiments a multi-port system could be used.

The temperature to which the insulating material 110 is heated depends on a number of factors, including the power of the microwave generator 1311, the length of the oven 1310, the formulation of the insulating material 110, including the water content thereof, the geometry of the bag, and the speed at which the bags 600 travel through the oven 1310. In an exemplary form, the oven is 12 feet long, the bags 600 travel up to 200 feet per minute, and a 100 kW 915 Mhz microwave generator is used. The actual line speed achievable will be determined by the length of time needed in the oven for the insulating material to reach the desired temperature. For example, using a longer microwave oven will allow a faster conveyor speed to be used.

The oven 1310 includes temperature sensors, such as infrared sensors, for measuring the temperature of the bags 600. Because the infrared sensors cannot measure the temperature of the insulating material 110 directly, which is contained between the substrates 102, 202, the sensors are configured to measure the surface temperature of the bag 600 proximate sections of insulating material 110. Preferably the surface temperature during activation reaches between 130° and 180° Fahrenheit. In some forms, the heating system 400 is configured to alter the speed of the conveyor 402 based on the measured temperature such that the insulating material 110 within the bags 600 is fully activated before exiting the oven 1310.

After activation of the insulating material 110, the finished bags 600 are transported from the oven 1310 along a cooling conveyor 414. The cooling conveyor 414 exposes the bags 600 to ambient air for sufficient time to cool them. In some forms, the cooling conveyor 414 may include a cooling tunnel, fans, and/or other cooling devices to expedite cooling. After the bags are cooled they are transported to the bundling station 418. In the bundling station 418 a plurality of bags 600 are stacked, bundled, and prepared for shipping.

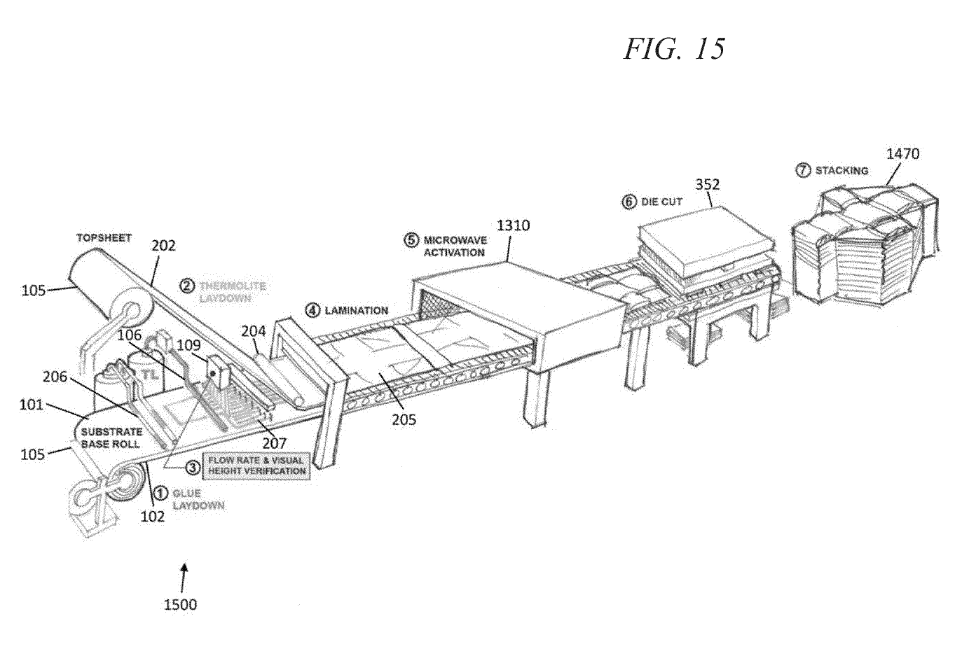

FIGS. 14A-15 illustrate two alternate systems or machine lines 1400 and 1500 for making an insulated insert 1470, which can be used to insulate conventional packaging, such as rectangular corrugated boxes. For example, the insulated inserts disclosed herein may be used to insulate perishable food packaging, such as boxes used to ship meal kits or groceries, or containers for medicine, lab specimens, or any other temperature sensitive material. Machine line 1400 utilizes a conventional heater 410 for activation of the insulating material, such as a heating element with or without convection fans. The machine line 1500 utilizes a microwave oven 1310 for activation.

Similar to the inserts disclosed in FIGS. 7-8C, the insulated laminated inserts 1470 having a top and bottom flexible substrate 102, 202 that are bonded together with an adhesive along its edges, and contains an air gap between the inner facing surfaces of the substrates provided by expanded insulating material 110 bonded to at least one of the inner facing surfaces of the substrates. The insulating material 110 is arranged in a pattern of small individual sections 111. In one form, the pattern comprises a plurality of rows and columns of rectangular sections 111 as shown.

As shown in FIG. 14B, the insulated laminated insert 1470 has a cross-like shape with two end walls 1472, two sidewalls 1474, and a bottom panel 1471. In some forms, each end wall 1472 or each sidewall 1474 includes a top wall portion 1473, each approximately half the size of the bottom panel 1471. Alternatively, one end wall 1472 or one sidewall 1474 includes a single top wall portion 1473 approximately the size of the bottom panel 1471.

Each end wall 1472 is connected to each sidewall 1474 by a gusset or webbing 1476. Each gusset 1476 is divided into two triangular sections 1477 by a crease or fold line 1475. The end walls 1472, sidewalls 1474, bottom panel 1471, and top wall portions 1473 each contain insulating material 110. The gussets 1476 do not contain insulating material.

In operation, the insulated laminated insert 1470, see FIG. 14B, is configured to be shifted from a flat configuration for storage as shown in FIG. 15A to a folded orientation for being placed inside a box, bag, or other hexahedral container to serve as an insulating inner layer adjacent the interior walls of a container. The bottom panel 1471 rests on the bottom of the container. The end walls 1472 and sidewalls 1474 fold up, along fold lines 1472a and 1474a respectively, by approximately 90 degrees relative to the bottom panel 1471. When the walls 1472/1474 are folded up, the gussets 1476 fold in half along the fold line 1475, and then fold flat along the inner or outer surface of one end wall 1472 or sidewall 1474.

The container and insert 1470 can then be loaded with items before folding the top portions 1473 along fold lines 1473a by approximately 90 degrees relative to the walls 1472 to rest above or on top of the contained materials. In alternative embodiments, the size and shape of the inserts 1470 vary to be configured to fit in different containers.

The machine system 1400 shown in simplified form in FIG. 14A forms the inserts 1400 out of a first substrate 102 and second substrate 202 which are dispensed from rollers 105. The substrates are preferably made of paper, such as kraft paper. As in the other disclosed processes, the first substrate 102 is fed by a series of rollers 104 to an applicator 106. As discussed above, the applicator 106 is one of a silk screen, printer, nozzle, or other known applicator. In this form, the applicator 106 is a series of nozzle applicators. The nozzle applicators apply the insulating material 110 in liquid form to a first side or surface 101 of the first substrate 102. For some applications, the outer surface of one or both substrates 102/202 may be pre-treated with a water barrier coating. The insulating material 110 is an expandable insulating material activated by heating.

The insulating material 110 is applied to the first substrate by the applicator in columns of sections 111. After application the visual inspector or vision system 109 inspects the pattern as described above. An adhesive applicator 206 applies a seam adhesive 207 proximate the borders or edges of the insert 1470. In a preferred form, the insulating material 110 is completely surrounded by adhesive on the surface 101 of the substrate 102, such that when the laminate 205 is formed the seam adhesive 207 provides a seal to inhibit passage of the insulating material 110 from between the substrates 102, 202. The second substrate 202 is applied to the first surface 101 of the first substrate 102, and the two substrates are pushed together by nip rollers 204. In some forms, the rollers 204 comprise a series of rollers positioned to compress the laminate 205 along the seam adhesive 207 but not the insulating material 110.

As shown in FIG. 15, the order of the seam adhesive applicator 206 and the applicator 106 can be changed. The seam adhesive 207 and insulating material 110 do not overlap, so they can be applied in either order.

In some forms, such as shown in FIG. 14A, the insulating material 110 is pre-dried by a dryer 107, such as an infrared dryer, before application of the second substrate 102. The pre-drying process increases the viscosity of the insulating material 110, such that it is more resistant to smearing during the lamination process. Pre-drying may also be used to reduce wrinkling of the first or second substrates 102/202 as a result of moisture from the insulating material 110 being absorbed by the paper. In a preferred form, the insulating material 110 is pre-dried when a conventional oven 410 is used for activation and not pre-dried when a microwave oven 1310 is used for activation.

In the conventional oven system 1400, a die cutter 352 cuts the laminate 205 into blanks 1479, see FIG. 14B, for the insert 1470. In addition to cutting the laminate 205, the die cutter 352 scores the fold lines of the insert 1470 to aid in the folding described above. The pressure of the die cutter 352 on the laminate 205 may cause wet insulating material 110 to smear, so in a system 1500 without a dryer 107 the die cutter can be placed after the heater 1310 for forming the blanks after the insulating material has been expanded and dried.

As shown in FIGS. 15 and 14A, the unexpanded laminate 205 (FIG. 15) or blanks 1479 (FIG. 14A) are fed into the conventional oven 410 or microwave oven 1310, respectively, for activation. Activation of the expandable insulating material 110 is substantially the same as described above. In some forms, the heater 1310 includes temperature sensors to measure the surface temperature of the substrate 202 or 102. Additionally or alternatively, a gauge or optical sensor located downstream of the conventional or microwave oven 410/1310 measure the thickness of the inserts to confirm sufficient expansion of the insulating material 110. The conventional or microwave oven 410/1310 heat the insulating material 110 as described above to expand the microspheres contained therein without causing them to rupture.

After being formed and activated, the inserts 1470 are stacked and bundled for shipping. In one form, the inserts 1470 are shipped in the flat position shown. The inserts 1470 can then be folded up at a second location for being inserted into a container to be insulated prior to loading the container, for example distribution centers for grocery or prepared meal delivery.

FIG. 16A illustrates a simplified representation of a system or machine line 1600 for forming insulated laminate inserts 1670 out of a single sheet 1602 of material, such as kraft paper. The sheet 1602 is dispensed from a roll 105. The sheet 1602 has two halves, a first substrate section or ply portion 102 and second substrate section or ply portion 202 divided by a fold line 1673. An insulating material applicator 106 applies insulating material 110 to the top surface 101 of the first substrate section 102. The applicator 106 can be any of the applicators 106 described above, such as a series of nozzles. A vision system 109 is located downstream of the applicator 106 to monitor the pattern of insulating material 110. In some forms, the vision system 109 can further monitor the thickness of the insulating material 110 coating.

In some forms, the insulating material 110 is applied in three different spaced apart sections as shown on the insert blank 1679 in FIG. 16B. The sections are separated by folding areas 1674. In some forms, the folding areas 1674 may be scored to aid in later folding by a user. In operation, the insert 1670 is folded along the folding areas at 90 degree angles such that the three portions lie adjacent and insulate three walls (for example two opposite side walls and a bottom) of a box. A second insert 1670 is similarly folded to insulate the other three walls of the same box (for example the remaining opposite end walls and the top).

A seam adhesive applicator 206 applies a seam adhesive 207 along the exterior edge 1671 of the first substrate section 102. In some forms, the seam adhesive applicator 206 also applies seam adhesive in lines perpendicular to the side edge along what will be the ends of the insert 1670.

A tilter or folder 1610 folds the second substrate section 202 over to cover the first side 101 of the first substrate section 102 to form an unexpanded laminate 205. The folder 1610 includes one or more of rails or rollers to gradually fold the sheet 1602 in half along fold line 1673. After folding, a roller 204 presses the two substrate sections 102/202 together along the seam adhesive 207.

In the system 1600 shown, the laminate 205 enters a microwave heater 1310. The microwave oven 1310 operates substantially similar as described above. In alternative forms, a conventional heater 410 is used to activate and expand the insulating material 110. For systems 1600 with conventional heaters 1410, a dryer 107 may be used to pre-dry the insulating material 110 upstream of the folder 1610. As shown, at least the upstream end of the laminate 205 remains open during the microwave process such that moisture is allowed to exit the laminate while the insulating material is being activated.

After activation, the ends 1671 of the inserts 1670 are crimped by a crimper 1675. The crimper 1675 may additionally crimp the side edge of the laminate 205 along the seam adhesive 207. The substrate is then cut along the end crimps to form discrete inserts 1670. A polymer coating may also be applied to the inner surface of the substrate 102, such that when heat is applied by the crimper 1675, the polymer coating melts and bonds the substrate sections together. Accordingly, the edges of the insulated laminate insert may be sealed by seam adhesive 207, a melted polymer coating, and/or the mechanical bond formed by crimper 1675.

Turning to FIG. 16B, a blank 1679 that forms the insulated laminate insert 1670 is rectangular having a width prior to lamination of 36 inches wide by 35 inches long. The size of the blanks 1679 may vary in size and/or shape for different applications. For example, the blanks 1679 may be shaped like the bottom of a box or container to be used as an insulating insert 1670. In some forms, the unexpanded laminate 205 made from a single sheet 1602 is fed directly into a bag making system 300 or insert making system 350. In still further alternatives, the laminate 205 is rolled up after activation to be formed into insulated laminates at a later time and/or separate location.

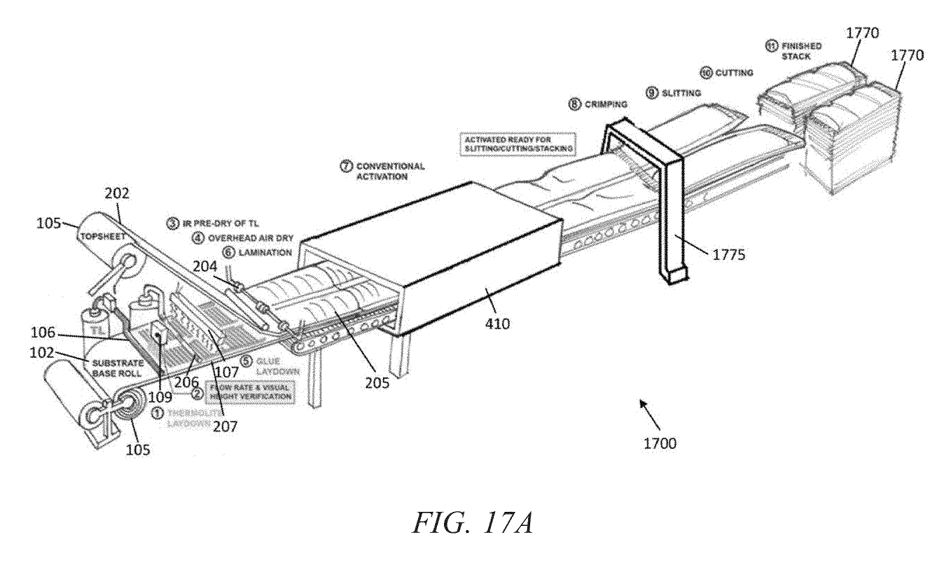

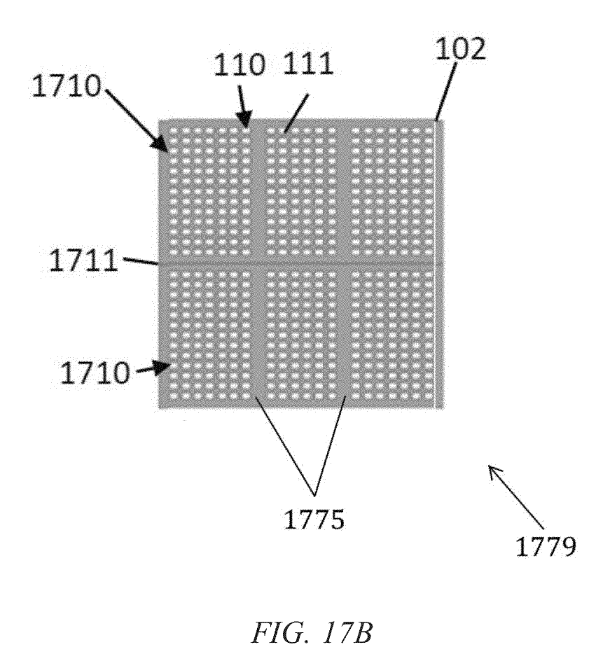

FIG. 17A illustrates an alternative machine line 1700 for making into insulated laminate inserts 1770 similar to the inserts 1670. Instead of a single sheet 1602, the machine line 1700 uses two separate substrates 102 and 202 as in other previous embodiments. The applicator 106 applies insulating material 110 in two identical patterns 1710 repeated on either side of the of the longitudinal center line 1711 of the substrate 102. A vision system 109 confirms that the insulating material 110 is applied in the proper pattern 1710. As shown in FIG. 17B, an exemplary blank 1779 which is formed into insert 1770 has the insulating material 110 is applied in three sections separated by folding areas 1775 so the insert 1770 can be used in the same manner as the insert 1670 to insulate a hexahedral container as described above.

The seam adhesive applicator 206 applies the seam adhesive 207 along what will be the side edges of the insert 1770. In some forms, the seam adhesive is applied in four longitudinal strips. Two strips are located proximate the side edges of the first substrate 102. Two other strips are located proximate the center line 1711 of the first substrate 102. In some forms, the two center strips are connected such that they form a single, double-wide strip. The insulating material 110 is positioned between an outside strip and the nearest center strip such that when the expanded laminate 205 is formed and is split into inserts 1770, the insulating material 110 is sealed within the substrates 102, 202 on both sides of the insert 1770 by a strip of seam adhesive 207 along outer side edges of the insert 1770.

The second substrate 202 is then applied to the top surface 101 of the first substrate 102 and the two are pressed together by nip rollers to form an unexpanded laminate 205. In some forms, a dryer 107 partially pre-dries the insulating material 110 before lamination. In a preferred form, the dryer 107 is used in line 1700 with a conventional heater 410.

The laminate 205 is fed into a conventional oven 410 to activate the microspheres in the insulating material 110, causing the insulating material 110 to expand. The heater 410 is a conventional heater as the heaters 410 described above. Alternatively, a microwave oven 1310 can be used. In some forms a temperature sensor, visual sensor, and/or gauge is used as quality control to monitor the activation process by measuring the surface temperature of the laminate 205 and/or the thickness of the laminate 205 after activation.

After activation, the laminate 205 is fed into a cutter 1775. The cutter 1775 cuts the laminate 205 into discrete inserts 1770. In some forms, the cutter 1775 additionally crimps the edges of the inserts 1770. The cutter 1775 may comprise a plurality of separate machines for performing different cutting and crimping processes. The cutter 1775 includes a slitter positioned and configured to continuously slit along the longitudinal axis of the laminate 205 splitting the laminate into two inserts 1770. A crimper creates crimps perpendicular to the slit and spaced apart to define the sealed ends of the individual inserts 1770. In some forms, the crimps are 35 inches apart on center. A cutter cuts along the width of the laminate 205 proximate the center of each crimp dividing the laminate into individual blanks 1770. After cutting, the inserts 1770 are stacked and prepared for shipping. The inserts 1770 may be used as insulated inserts for packages, such as grocery or food delivery packages.

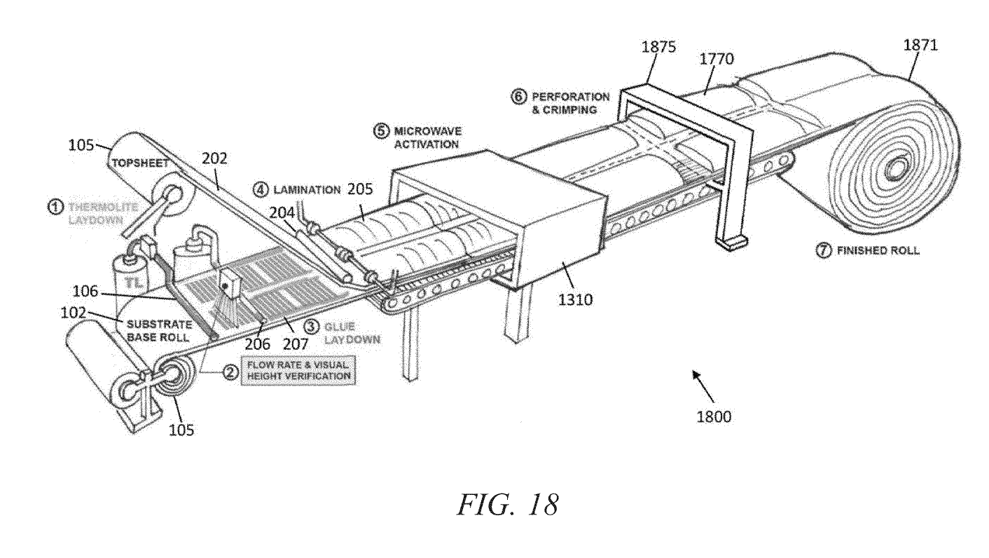

In some forms, as illustrated in FIG. 18, the inserts 1770 are not separated before shipping. In the machine line or system 1800 the cutter 1775 is replaced with a perforator 1875. Instead of separating the laminate 205 into discrete inserts 1770, the perforator 1875 perforates the seams between the inserts 1770 such that they can be easily torn apart at a later time. In some forms, the perforator 1875 additionally crimps the seams to seal the ends of the inserts 1770.

The system 1800 shown in FIG. 18 also differs from the system 1700 shown in FIG. 17A in that it implements a microwave oven 1310 instead of a conventional oven 410, and lacks a dryer 107. However, just as the system 1700 may have a microwave oven 1310 as shown in FIG. 18, the system 1800 may have a conventional oven 410 as shown in FIG. 17.

After perforation, the laminate 205 is rolled into a roll 1871. The roll 1871 can then be transported to a second location or stored for future use.

It is thus seen that a flexible laminate with a thermally activated expanded insulating material positioned between the two plies of the same or different kinds of substrate, and products made from said laminate, including bags and inserts, may be provided and used in accordance with the foregoing teachings.

In addition, one skilled in the art will appreciate variations in the above-described flexible insulating laminate and products made therefrom can be provided. For example, the laminate 205 can be formed into envelopes or sleeves or other flexible containers. Additionally, one skilled in the art will appreciate that a variety of methods and systems for making an insulated laminate are contemplated in addition to those explicitly described above.

Those skilled in the art will recognize that a wide variety of modifications, alterations, and combinations can be made with respect to the above described embodiments without departing from the spirit and scope of the invention, and that such modifications, alterations, and combinations, are to be viewed as being within the scope of the invention.

What is claimed is:

1. A flexible laminate, comprising:
first and second flexible ply portions each having inner facing surfaces that are bonded together with an adhesive along at least one edge of the first and second ply portions;
an expanded insulating material including expanded microspheres disposed on at least one of the inner facing surfaces of the first and second ply portions to space the ply portions apart and form at least one air void between the ply portions, wherein the expanded insulating material is spaced inwardly from the at least one edge of the bonded first and second ply portions and the adhesive extends about the insulating material to keep the expanded insulating material from passing beyond the at least one edge of the bonded first and second ply portions.

2. The flexible laminate of claim 1, wherein the ply portions are two separate plies of material.

3. The flexible laminate of claim 1, wherein the ply portions are of a single ply of material folded over upon itself with the ply portions extending from a common fold line.

4. The flexible laminate of claim 1, wherein the ply portions are of a paper material.

5. The flexible laminate of claim 1, wherein an outer surface of one of the first and second ply portions is coated with a water-resistant coating.

6. The flexible laminate of claim 5, wherein the ply portion having the outer surface with the water-resistant coating has a Cobb value of less than 25 g/m̂2.

7. The flexible laminate of claim 1, wherein the adhesive forms a continuous perimeter around the expanded insulating material to seal the expanded insulating material within the at least one edge of the bonded first and second ply portions.

8. The flexible laminate of claim 1, wherein the bonded first and second ply portions with the expanded insulating material and adhesive therebetween are formed into a collapsible bag with a base and opposing side and end walls extending from the base, the opposing side and end walls forming a bag opening at uppermost edges of each of the side and end walls opposite from the base, wherein an exterior surface of the bag is formed by one of the first and second ply portions, and interior surface of the bag is formed by the other of the first and second ply portions.

9. The flexible laminate of claim 8, wherein the opposing side and end walls are separated by preformed fold lines that extend from the base, and wherein the expanded insulating material is spaced from each of the fold lines.

10. The flexible laminate of claim 8, wherein the opposing side and end walls each have a length measured from the base to the uppermost edge thereof and each of the opposing side and end walls each include an upper portion extending from the uppermost edge toward the bag base free from expanded insulating material, wherein the length of the upper portion free from expanded insulating material is at least one eighth of the length of the respective opposing side or end wall.

11. The flexible laminate of claim 8, wherein the adhesive extends between the first and second ply portions along the uppermost edges of each of the side and end walls in a non-continuous manner.

12. The flexible laminate of claim 8, wherein the adhesive forms a continuous perimeter around the expanded insulating material to seal the expanded insulating material within the at least one edge of the bonded first and second ply portions.

13. The flexible laminate of claim 1, wherein the expanded insulating material is configured to provide the flexible laminate with an R-value between 0.05 m̂2 K/W to 0.5 m̂2 K/W.

14. The flexible laminate of claim 1, wherein the first and second ply portions with the expanded insulating material and adhesive therebetween are formed into an envelope.

15. The flexible laminate of claim 1, wherein the expanded insulating material is arranged in a pattern of individual spaced apart portions that are aligned in a plurality of columns.

16. The flexible laminate of claim 1, wherein the expanded insulating material has a thickness between 0.1 and 0.5 inches.

17. A method of making a flexible insulating laminate, comprising:
applying an insulating material in an unexpanded form in a pattern to a first side of a first substrate portion;
applying an adhesive material different from the unexpanded insulating material to the first side of the first substrate portion so that the adhesive material surrounds and is spaced from the unexpanded insulating material;
bonding a second substrate portion to the first side of the first substrate portion via the adhesive material to form an unexpanded laminate having the unexpanded insulating material disposed between the first and second substrate portions with the adhesive material surrounding and spaced from the unexpanded insulating material; and
heating the unexpanded laminate to cause the unexpanded insulating material to expand to provide at least one air void between the bonded first and second substrates to form the flexible insulating laminate.

18. The method of making a flexible insulating laminate of claim 17, further comprising forming the unexpanded laminate into a collapsible bag.

19. The method of making a flexible insulating laminate of claim 17, wherein the step of heating the unexpanded laminate occurs after forming the unexpanded laminate into a collapsible bag.

20. The method of making a flexible insulating laminate of claim 18, wherein forming the unexpanded laminate into a collapsible bag includes forming fold lines in the unexpanded laminate for collapsing and expanding the bag in locations that are spaced from the unexpanded insulating material.

21. The method of making a flexible insulating laminate of claim 17, wherein the unexpanded laminate is heated using an industrial microwave.

22. The method of making a flexible laminate of claim 17, wherein the unexpanded insulating material is heated to a temperature of between 200 and 250 degrees Fahrenheit to cause expansion of the insulating material.

23. The method of making a flexible insulating laminate of claim 17, wherein the unexpanded insulating material includes unexpanded microspheres prior to heating of the insulating material, and after heating of the insulating material within a predetermined activation temperature range, the expanded insulating material comprises unruptured expanded microspheres.

24. The method of making a flexible insulating laminate of claim 17, wherein the unexpanded insulating material has a viscosity of between 3,000 and 4,500 centipoise at 72 degrees Fahrenheit.

25. The method of making a flexible insulating laminate of claim 17, wherein the unexpanded insulating material has a thickness ranging between 2 and 30 mil prior to being expanded by heating.

26. The method of making a flexible insulating laminate of claim 17, wherein the unexpanded insulating material is applied to the first substrate while the first substrate is advanced at a speed greater than 100 ft/min.

27. The method of making a flexible insulating laminate of claim 17, further comprising heating the unexpanded laminate to remove moisture from the unexpanded insulating material and allowing the dried insulating material to cool prior to heating the unexpanded laminate to cause the unexpanded insulating material to expand.

28. The method of making a flexible insulating laminate of claim 17, wherein the first substrate is advanced at a predetermined speed;
measuring the speed at which the first substrate is advanced; and
the unexpanded insulating material is applied in the pattern repeatedly at predetermined spaced apart locations on the first substrate based on the measured speed of the first substrate.

29. The method of making a flexible insulating laminate of claim 17, wherein the adhesive material is applied to form a continuous perimeter about the unexpanded insulating material to seal the unexpanded insulating material between the bonded first and second substrate portions.

30. The method of making a flexible insulating laminate of claim 17, further comprising forming fold lines in the bonded first and second substrate portions at predetermined locations spaced from the insulating material.

31. An inline system for making a flexible insulated laminate, comprising
a roll for feeding a web of a first substrate to be processed;
a roll for feeding a web of a second substrate to be processed;
an insulating material applicator to apply a heat expandable insulating material to the first substrate web at predetermined insulating material locations on the first substrate web while the first substrate web is advanced in a machine direction;
an adhesive applicator to apply an adhesive material to the first substrate web at predetermined adhesive locations on the first substrate web spaced from the applied expandable insulating material while the first substrate web is advanced in the machine direction;
a pair of nip rolls to bond the second substrate web to the first substrate web at the predetermined adhesive locations while the substrate webs are advanced in the machine direction;
a bag converter to convert the bonded first and second substrates into a collapsible bag while the bonded substrates are advanced in the machine direction; and
a heater to heat the expandable insulating material disposed between the first and second substrates to cause the insulating material to expand while the bonded substrates are advanced in the machine direction.

32. The inline system for making a flexible insulated laminate of claim 31, wherein the insulating material applicator is a nozzle applicator having a plurality of nozzles for applying heat expandable insulating material arranged in a plurality of columns to the first substrate web.

33. The inline system for making a flexible insulated laminate of claim 32, further comprising a flowmeter for measuring the amount of heat expandable insulating material applied to first substrate by the nozzle applicator.

34. The inline system for making a flexible insulated laminate of claim 31, further comprising a vision system having an optical detector for confirming the applied heat expandable insulating material is located at the predetermined insulating material locations on the first substrate.
